(19) United States
(12) Patent Application Publication
(10) Pub. No.: US 2023/0337008 A1
(43) Pub. Date: Oct. 19, 2023

(54) METHODS AND DEVICES FOR INTER-NETWORK COMMUNICATION

(71) Applicant: Fraunhofer-Gesellschaft zur Förderung der angewandten Forschung e.V., München (DE)

(72) Inventors: Thomas HAUSTEIN, Berlin (DE); Jasmina MCMENAMY, Berlin (DE); Paul Simon Holt LEATHER, Berlin-Schlachtensee (DE)

(21) Appl. No.: 18/337,480

(22) Filed: Jun. 20, 2023

Related U.S. Application Data
(63) Continuation of application No. PCT/EP2021/087236, filed on Dec. 22, 2021.

(30) Foreign Application Priority Data
Dec. 22, 2020 (EP) 20216543.7

(51) Int. Cl. H04W 16/14

(52) U.S. Cl. CPC H04W 16/14

(57) ABSTRACT

A control unit configured for controlling communication of members of a first communication system is to transmit a first signal relating to a configuration of the first communication system or a different second communication system and/or to receive a second signal relating to the configuration of the first communication system or the second communication system.

### CROSS-REFERENCE TO RELATED APPLICATIONS

This application is a continuation of copending International Application No. PCT/EP2021/087236, filed Dec. 22, 2021, which is incorporated herein by reference in its entirety, and additionally claims priority from European Application No. EP 20216543.7, filed Dec. 22, 2020, which is also incorporated herein by reference in its entirety.

The present application concerns the field of inter communication system communication, e.g., in the field of wireless communication. The present application further relates to a new radio control channel for coordination for wireless communication systems.

### BACKGROUND OF THE INVENTION

Current wireless communications systems operate either in dedicated spectrum blocks, which guarantees the exclusive use of spectrum or they operate in the unlicensed spectrum bands such as 5 GHz band, where different systems (e.g. Wi-Fi, Bluetooth, 4G LAA, NR-U etc.) coexist by adhering to certain spectrum usage etiquette. In broad terms, the common challenge in both cases is the lack of widely-adopted coordination mechanisms that will enable a more dynamic deployments and greater spectrum efficiency.

There is, thus, a need for providing a high level of inter-system communication with the purpose of coordination of shared resources in order to improve efficiencies and quality of service of at least one of the networks.

### SUMMARY

An embodiment relates to a control unit configured for controlling communication of members of a first communication system; wherein the control unit is to transmit a first signal relating to a configuration of the first communication system or a different second communication system; and/or to receive a second signal relating to the configuration of the first communication system or the second communication system.

Another embodiment relates to a base station for a communication system including an inventive control unit.

Another embodiment relates to a peer for a peer-to-peer communication system including an inventive control unit.

Another embodiment relates to an apparatus to communicate with a first control unit configured for controlling communication of members of a first communication system; and with a second control unit configured for controlling communication of members of a second communication system; wherein the apparatus is configured for receiving a first signal from the first control unit, the information being mapped to a first message space and for mapping the first signal to a second, different message space and for providing the second signal to the second control unit using the second message space.

According to another embodiment, an apparatus configured to operate in a first communication system based on a control from a control unit may have: an interface; wherein the apparatus is configured for transmitting a signal to the control unit using the interface, the signal including a request to the control unit to adapt an operating parameter of the first communication system or to adapt an operating parameter of a second communication system.

According to another embodiment, an apparatus configured to operate in a first communication system based on a control from a control unit may have: an interface; wherein the apparatus is configured for transmitting a signal to the control unit using the interface, the signal including a request to the control unit to adapt an operating parameter of the first communication system according to requests received from members or a control unit of a second communication system.

According to another embodiment, an apparatus configured to operate in a first communication system based on a control from a control unit, may have: an interface; wherein the apparatus is configured for transmitting a signal to an entity of a further communication system using the interface, the signal including a request to a further control unit of the further communication system to adapt an operating parameter of the further communication system.

According to another embodiment, a communication scenario may have: a first communication system being controlled at least partly by a first inventive control unit; and a second communication system being controlled at least partly by a second inventive control unit; wherein a node of the first communication system is to transmit a signal to a node of the second communication system and/or wherein a node of the second communication system is to transmit a signal to a node of the first communication system.

A recognition of the present invention is by providing signals between control units controlling a respective communication system, it is possible to adapt control of at least one of the communication systems and to, therefore, provide for a high effectiveness of networks' operations.

According to an embodiment, a control unit configured for controlling communication of members of a first communication system is to transmit a first signal relating to a configuration of the first communication system or a second communication system and/or to receive a second signal relating to the configuration of the first communication system or the second communication system.

This allows to obtain knowledge that may form a basis for adaptation of at least one communication system.

According to an embodiment, an apparatus to communicate with a first control unit is configured for controlling communication of members of a first communication system, and with a second control unit, configured for controlling communication of members of a second communication system, and is configured for receiving a first signal from the first control unit, the information being mapped to a first message space. The apparatus is further configured for mapping the first signal to a second, different message space and for providing the second signal to the second control unit using the second message space. This allows transmission and/or reception of signals between different control units that are possibly unable to directly communication with each other.

According to an embodiment, an apparatus, configured to operate in a first communication system based on a control from a control unit, comprises an interface and is configured for transmitting a signal to the control unit using the interface; the signal comprising a request to the control unit to adapt an operating parameter of the first communication system or to adapt an operating parameter of a second communication system. This allows a controlled member that possibly recognizes a need for adaptation or suffers from a present configuration to request an adaptation of the configuration.

According to an embodiment, an apparatus, configured to operate in a first communication system based on a control from a control unit, comprises an interface and is configured for transmitting a signal to the control unit using the interface; the signal comprising a request to the control unit to adapt an operating parameter of the first communication system according to side constraints derived from an observed behavior of a second communication system. This may allow the control unit to be provided with additional information for controlling the communication system.

According to an embodiment, an apparatus, configured to operate in a first communication system based on a control from a control unit, comprises an interface and is configured for transmitting a signal to the control unit using the interface. The signal comprises a request to the control unit to adapt an operating parameter of the first communication system according to requests received from members or a control unit of a second communication system. This may allow to forward requests to the control unit, which is received by the member, e.g., when a direct communication between the control units is blocked.

According to an embodiment, an apparatus, configured to operate in a first communication system based on a control from a control unit, comprises an interface and is configured for transmitting a signal to an entity of a further communication system using the interface; the signal comprising a request to a further control unit of the further communication system to adapt an operating parameter of the further communication system. This enables the further communication system to be provide with instructions or information so as to provide for the high effectiveness of networks' operations.

According to an embodiment, a communication scenario comprises a first communication system and a second communication system. A node of the first communication system is to transmit a signal to a node of the second communication system and/or a node of the second communication system is to transmit a signal to a node of the first communication system. Further embodiments provide for methods for operating said devices or scenarios and for a computer readable digital storage medium having stored thereon a computer program having a program code for performing, when running on a computer, such a method.

### BRIEF DESCRIPTION OF THE DRAWINGS

Embodiments of the present invention will be detailed subsequently referring to the appended drawings, in which:

FIG. 1a-b show illustrations relating to spectrum sharing techniques in intra-technology and inter-technology scenarios and spectrum sharing design space at different protocol layers found in [7];

FIG. 2 shows different approaches for realisation of control channel discussed in conventional technology [9];

FIG. 3a shows a schematic block diagram of a communication scenario according to an embodiment;

FIG. 3b shows a schematic block diagram of a further communication scenario according to an embodiment;

FIG. 4 shows a schematic block diagram of a communication scenario according to an embodiment comprising two basestations;

FIG. 5 shows a schematic block diagram of a communication scenario according to an embodiment in which two wireless communication systems provide coverage to two geographic regions that overlap in part;

FIG. 6 shows a possible functional connection between multiple communication systems via a control channel to a common database or a spectrum management system according to an embodiment;

FIG. 7 shows an example of a wireless communication system (WCS) using a particular radio access technology according to an embodiment;

FIG. 8 shows an example of a wireless communication system using a different particular radio access technology according to an embodiment;

FIG. 9 shows an example of a wireless communication system using a particular radio access technology and two control units according to an embodiment;

FIG. 10 shows an example of a wireless communication system using a different particular radio access technology and multiple control units according to an embodiment;

FIG. 11 shows an example of multiple wireless communication systems of a communication scenario according to an embodiment;

FIG. 12 shows a further example of multiple wireless communication systems of a communication scenario being used for maritime and terrestrial applications according to an embodiment;

FIG. 13 shows an example of multiple wireless communication systems of a communication scenario being used in road transport and factory or distribution centre applications according to an embodiment;

FIG. 14 shows a second example of multiple wireless communication systems of a communication scenario being used in road transport and factory or distribution centre applications according to an embodiment;

FIG. 15 shows an example of simple spectrum sharing between three mobile network operators according to an embodiment;

FIG. 16 shows an example of spectrum allocation according to an embodiment;

FIG. 17 shows a schematic block diagram of a communication scenario according to an embodiment comprising, for example, at least three communication systems;

FIG. 18 shows a schematic block diagram of an apparatus according to an embodiment, which may be referred to as a polyglottal attaché;

FIG. 19 shows a schematic block diagram of an apparatus according to embodiment forming a possible member of a communication scenario described herein; and

FIG. 20 shows a schematic block diagram of a further communication scenario according to an embodiment.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Embodiments described herein relate to communication systems. A communication system may be understood as a system that allows for transmission and/or reception of signals to transport information. Such a communication system may be a wireless communication system, e.g., to transport radio signals, an optical communication system to exchange optical signals, a wired communication system to exchanged wired signals but may also be a combination of two or more of the above-mentioned. Although some of the embodiments described herein relate to wireless communication systems (WCS), the embodiments are not limited hereto, but relate, without limitation, to an optical communication system, a wired communication system, and/or a combination of a wireless communication system, and optical communication system and/or a wired communication system.

Embodiments describe herein make reference to members of a communication system. Such a member may relate to any network element such as at least one of:
A user equipment, UE;
A base station, gNB;
An integrated access and backhaul node—IAB;
A relay;
A control unit, CU;
A functional element which is part of the decision and control loop to configure or reconfigure a communication system.

Amongst those members, some embodiments make reference to a control unit that controls communication of members, i.e., of itself and other members, within the communication system. Such a communication may be a centralized communication, at least in parts, and/or a distributed communication amongst members, at least in part, e.g., a point-to-point (p2p) communication

A control unit being described herein may be implemented as a single entity but may also comprise a set of distributed control units operating cooperatively or collaboratively. As cooperatively one may understand an interaction for the sake of achieving individual goals, whilst as collaboration one may understand an interaction for the sake of achieving a joint goal. Such a set of distributed control units may also operate autonomously, e.g., without cooperation or semi-autonomously. The set of distributed control units may operate cooperatively or autonomously/semi-autonomously in different time instances, e.g., based on different operating modes of the communication system and/or for different network areas, network resources or the like. That is, both implementations of cooperating or non-cooperating or semi-cooperating control units do not exclude each other. A control unit in accordance with present embodiments may control communication of a member of its communication network with an infrastructure thereof and/or with other members of the communication system.

Embodiments provide for solutions to exchange signals between different communication systems (CS) to allow an adjustment of operation and, thereby, to a high effectiveness. In this context, spectrum sharing technologies have advanced significantly in the last few decades and dynamic spectrum access (DSA) techniques have become already included in multiple standards in different frequency bands and regulatory frameworks. The most widely accepted DSA systems such as the licensed shared access (LSA) and the citizens' broadband radio service (CBRS) use database approach. The databases, typically accompanied by some form of spectrum control/management entities, use historical spectrum data over different time-scales and make decisions on spectrum use over short and long time periods. While these database-driven models enable a reliable and cost-effective approach to enabling and managing spectrum sharing among multiple classes of spectrum users with different access rights and radio network technologies [3], they also pose challenges. They include, e.g. the inability for fast dynamic adaptation that follows variations in traffic demand, delays due to registration and deregistration of systems, complex hierarchical priority structure of spectrum users and others, outlined later in this section. The present disclosure addresses some of these challenges by proposing a new radio control channel for coordination of wireless communication systems, wherein this relates, without limitation, to non-radio embodiments and, thus, to new control channels.

Embodiments, hence, address the following use cases, but are not limited to these scenarios:
1) Flexible TDD, inter-operator adjacent channel interference. Flexible TDD is one of the major features of 5G, providing an inherent flexibility to cater for a highly asymmetric uplink (UL) and downlink (DL) traffic patterns. However, one of the major challenges in Flexible TDD deployments is the emergence of cross-link interference, as the UL/DL patterns of the neighbouring nodes/close-by UEs may not be the same. 3GPP has standardised CLI (and RIM) mechanisms for a single operator's network—see [1] and associated documents. However, dynamic TDD also causes interference between different networks on adjacent channels. Managing interference between different networks will become increasingly cumbersome as many more bands in FR2 open for wireless communication and with scenarios featuring multi-hop relay infrastructure (IAB nodes), vehicular cellular communication and D2D communication. While 3GPP has produced a set of recommendations based on the evaluation of different deployment scenarios (macro, micro, indoor, outdoor) [2], the recommendations impose restrictions on possible deployments and inhibit flexible deployments for future use cases.
2) NR-U, single/multi-operator scenarios. Another important use case pertinent to the invention is NR in unlicensed spectrum (NR-U). NR-U enables different technologies—e.g., NR and Wi-Fi to coexist in the same spectrum (in the same area). In addition, the NR-U use cases may also involve a single operator as well as NR-U multi-operator scenarios. The NR-U technology conceptually incorporates Listen before Talk (LBT) to ensure fair coexistence with Wi-Fi_33. Nevertheless, the LBT mechanism and its variants in NR-U (i.e. directional LBT) use energy detection to sense the channel occupancy, which is not spectrally efficient and provides no spectral resolution of sources and their identities. Furthermore, the LBT concept does not provide a mechanism to signal future intentions/actions, e.g. pre-booking a channel which is not pre-booked by someone else (pre-booking needs ways to communicate between systems). Hence, inter-RAT coexistence and coordination, which goes beyond rules for fair to access ISM channels is lacking. The existing mechanisms may work in the case of sparse reuse of channels by systems/links using the same or different RATs but do not scale well with high traffic demands or node density, therefore sacrificing spectral efficiency and reliability to preserve simplicity in the channel access procedure.
3) Database-centric frameworks for coordination of spectrum use. Currently, two major spectrum management frameworks—namely, Licensed Shared Access (LSA) in Europe, focusing on 2.3 GHz, and Citizens Broadband Radio Service (CBRS) at 3.5 GHz in the US use a fully-fledged database (DB)-centric approach. While these database-driven models enable reliable and cost-effective approach to enabling and managing spectrum sharing among multiple classes of spectrum users with different access rights and radio network technologies [3], they also pose challenges. For example, in the case of CBRS, its pivot—the Spectrum Access System (SAS) contains not only a repository that stores the information on current spectrum users with all their transmission-related parameters, such as location, antenna parameters, transmission power etc., but also includes complex algorithms for computation of optimum spectrum use. However, the speed of operations is normally slower the more intelligent the system is [4] and depends, amongst others, on the requirement for storage of measurement results, the size of the area where the spectrum is managed, the number of spectrum users, protocols for interaction with the respective managements systems etc. Furthermore, the authors in [4] point out that field trial measurements have shown that with a current cellular equipment, the timescales of operation is quite slow (the order of several minutes). In addition to these aspects, the CBRS system is designed to protect the top two tiers from interference, but SAS does not deal with the lowest-tier's users and sharing of spectrum between them. On the other hand, the current LSA framework with the exclusive use of spectrum either by an incumbent or by a secondary spectrum user (MNO) is too static, and therefore, enhancements and more dynamic operations are needed. Furthermore, the pure database-centric approach brings along security and privacy concerns by unintentionally facilitating collection and aggregation of sensitive information that potential spectrum users may not desire to share [3]. In that respect, the current DB approaches lack the possibility for various spectrum users to decide on the level of information they are willing to share, depending on the frequency band and its use. Finally, with the opening up of large swaths of mmWave spectrum for cellular communication as well as with the more prevalent D2D communication (including V2X), the importance of smaller-area, faster and more adaptive spectrum-decisions becomes greater. This means that the DB approaches need to be complemented with other approaches, such as facilitating direct handshakes on spectrum use between different communication systems or incorporating the WCS's spectrum use reporting into decisions on spectrum use.

In summary, the data base approach, which involves systems and devices to register their existence and activity, can support co-existence by keeping/creating safe-zones and ensuring they are not overbooked by the co-located systems operating within the same spectrum. However, there are a few major challenges in a pure data base approach. These include:
Inability for fast dynamic adaptation, which can follow traffic demand and traffic variations

Delays due to registration and deregistration of systems and frequency use
Complex hierarchical priority structure e.g. primary—secondary user etc.
Coordination between systems of different RATs, which can be only done by using the allocated spectrum
Coordination between systems of the same RAT needs inter node coordination, which cannot be provided by a data base approach (potentially a data base may assist)
In the unlicensed bands, where Wi-Fi and NR-U operate, general spectrum access rules have to be followed. They operate on a very short time-scale, which cannot be supported by the current database approaches

The following paragraphs provide a couple of illustrative examples of technical solutions proposed as a part of 3GPP NR-U standardisation as well as a few relevant surveys and illustrative examples of the proposed solutions from academic/research literature. Selected works provide a broad overview of the relevant aspects of spectrum sharing and provide useful relevant pointers within the wealth of literature on the topic that has been extensively researched for the last few decades.

### Recent Approaches in 5G Standardization

In [5], the authors propose handshaking among NR-U gNB and UEs to enhance channel access efficiency (energy detection-based monitoring of channel occupancy, looking at NR-U signalling between competing NR-U gNBs and UEs (inter-operator) and intra-operator coordination).

For example, the contribution proposes the use of a handshaking mechanism for the competing gNB and UEs, but also proposes information exchange among both competing and cooperating NR devices operating in unlicensed bands. The handshaking is proposed to be done in two parts, where a gNB sends a request to the UE or set of UEs. After a possible scheduled suspension of the transmission by the gNB, the intended UE(s) that happen to complete an LBT process successfully respond to the gNB. One part may be detected and decoded by competing/cooperating NR-U devices which helps them e.g. to enhance the efficiency of their channel access among others. Likewise, the responding UE(s) may send the response in two parts where one part may be detected and decoded by competing/cooperating NR-U devices.

In [6], the authors observe that the current energy detection mechanism does not distinguish the same operator signal or the same system signal and can be overly conservative in a dense deployment. The authors propose to use a mechanism to distinguish its own network signal for better NR-unlicensed spatial reuse.

To achieve effective results, prior coordination of the frequency resources among the participating APs may be helpful. APs participating in Coordinated OFDMA transmissions may exchange the information of the advantageous (or not advantageous) frequency resources prior to coordinated transmissions. During Coordinated OFDMA transmissions, the Coordinating AP can use the information of the advantageous frequency resources to allocate sub-channels to participating APs.

### Recent Approaches in 5G Research

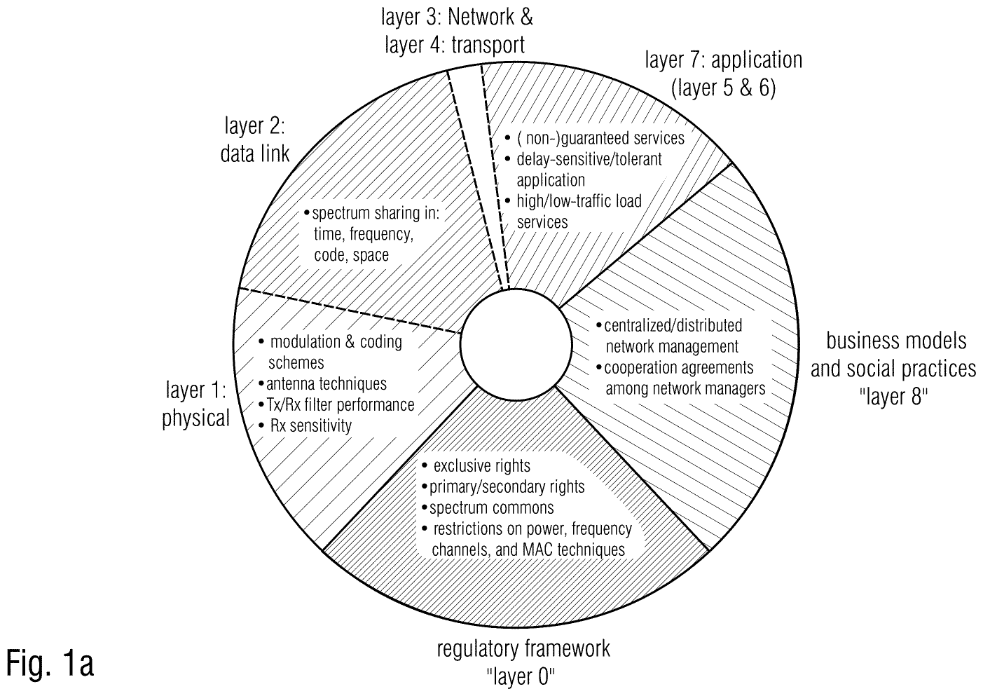

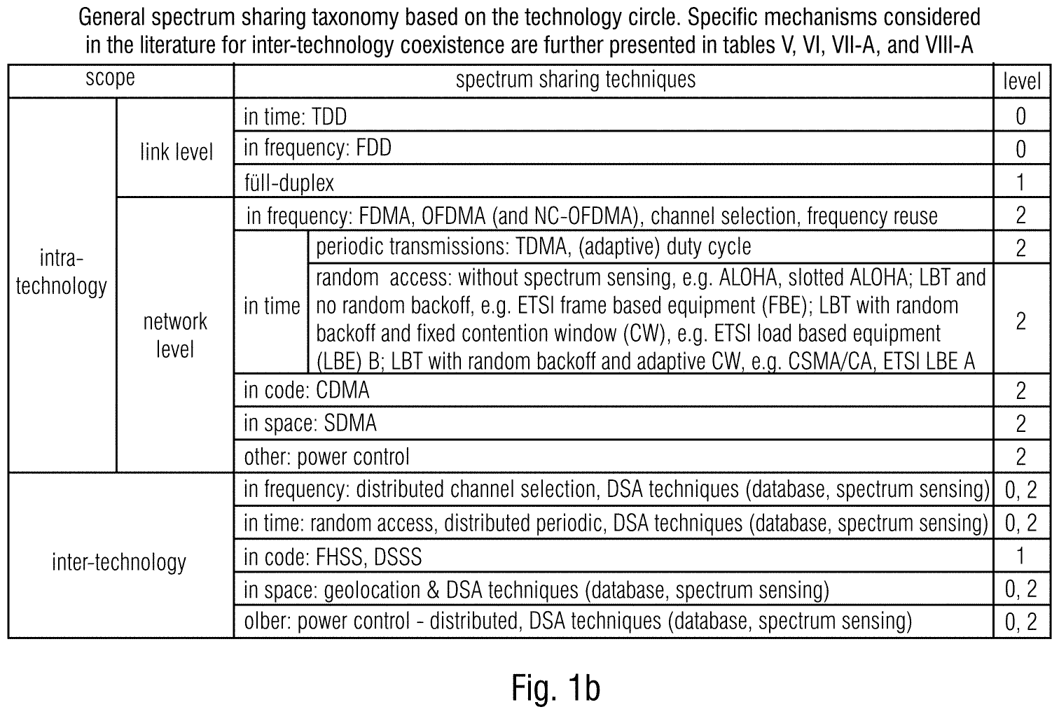

In [7], the authors address the aspects that effect design of efficient spectrum sharing mechanisms especially for inter-technology coexistence by using a multi-layer technology circle. The spectrum sharing design space is analysed through parameters at different layers of the protocol stack, as depicted by FIG. 1a and FIG. 1b showing illustrations relating to spectrum sharing techniques in intra-technology and inter-technology scenarios (left) and spectrum sharing design space at different protocol layers (right).

In a survey in [8], the authors focus on the research progress on spectrum sharing, focusing on full-duplex spectrum sensing, spectrum-database based spectrum sensing, auction-based spectrum allocation and carrier aggregation-based spectrum access. The authors discuss that one of the research issues that remains in Cognitive Radio Networks (CRN) for 5G networks and beyond is establishing reliable common control channel. Common control channel (CCC) is a control channel, devised for cognitive radio (CR) users, over which CR users can discover each other and establish communication to coordinate their access to the spectrum. The authors outline the challenges of having a dedicated Common Control Channel such as its availability, proneness to overloading etc. They refer to different sequence hopping schemes that do not require a centralised controller or dedicated common control channel, but can use stochastic hopping or specified hopping sequence.

Back in 2012, the authors in [9] provided an overview of techniques dealing with access to spectrum, spectrum sharing, spectrum handoff and other aspects of MAC in cognitive radio networks. Particularly, the work provides a comprehensive overview of the then proposed Common Control Channels in CRNs, used for exchanging signalling information, including sensing outcome, to perform channel selection. The authors point out that CCC enables interaction and coordination among the CRN users, but may saturate when the load increases. They also point out the need for additional dynamic strategies for a reliable exchange of signalling information, and synchronization within a neighbour cognitive radio.

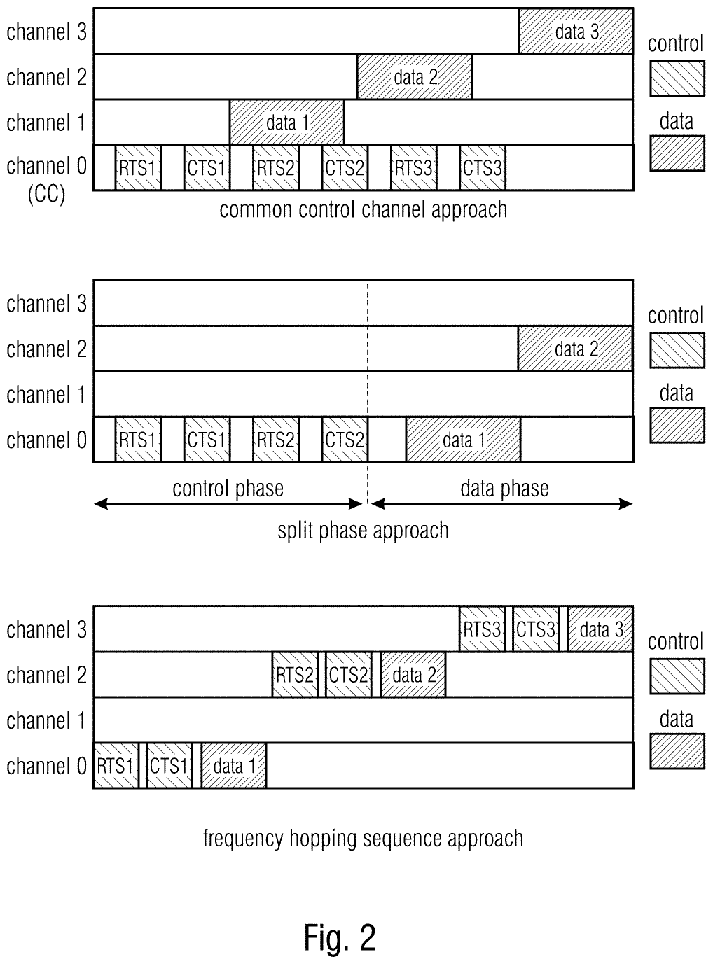

FIG. 2 showing different approaches for CCC realisation in [9], which depicts different approaches in realisation of CCC and might be related to the present invention. The figure depicts that CCC may be realised as dedicated control channel, in time-domain or using frequency-hopping scheme.

The aspects on spectrum sharing in mmWave cellular networks can be found in [10], [11]. In [10], the authors propose coordination between mmWave networks that partially overlap. They consider scheduled frame-based system that partitions radio resource for multiple access in the time and/or frequency domain, where the nodes within one network are synchronized in time and frequency and where there is at least time synchronization across networks. The main idea is the use of a coordinated blanking pattern, which is divided into available resource blocks and non-available resource blocks. Inter-network coordination is done via the so-called resource communication entities. Other base stations within the same network report on interference levels from their side, including the aggressor network ID. The coordinating entity processes them and includes them in blanking pattern request. In [11], the authors propose spectrum sharing coordination between different networks using a so-called Spectrum Sharing Manager. The coordination is performed locally and dynamically between basestations (BS). Adjacent BSs exchange coordination signals over the air to identify interference relationships and determine the intention of other BSs to access the spectrum. A common synchronization source for BSs is assumed. After these coordination signals are exchanged, each BS locally reserves a portion of the resource in the time domain and executes the actual data transmission.

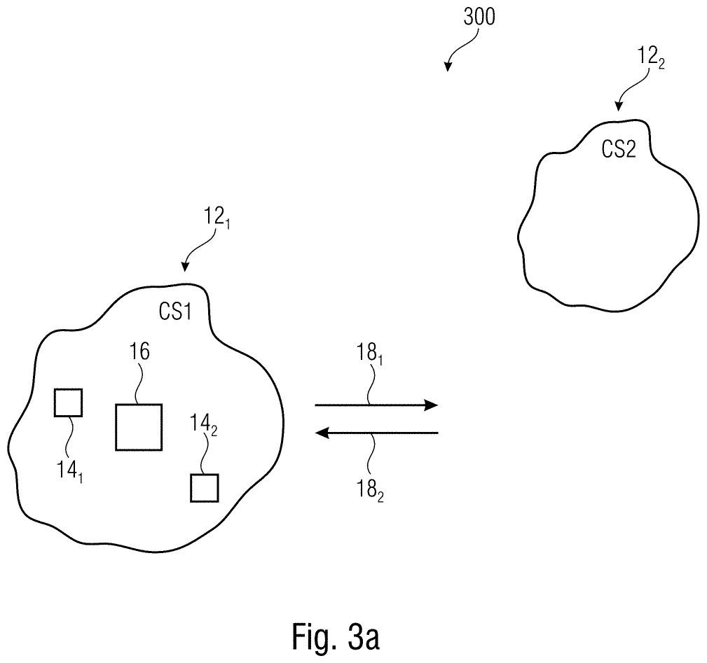

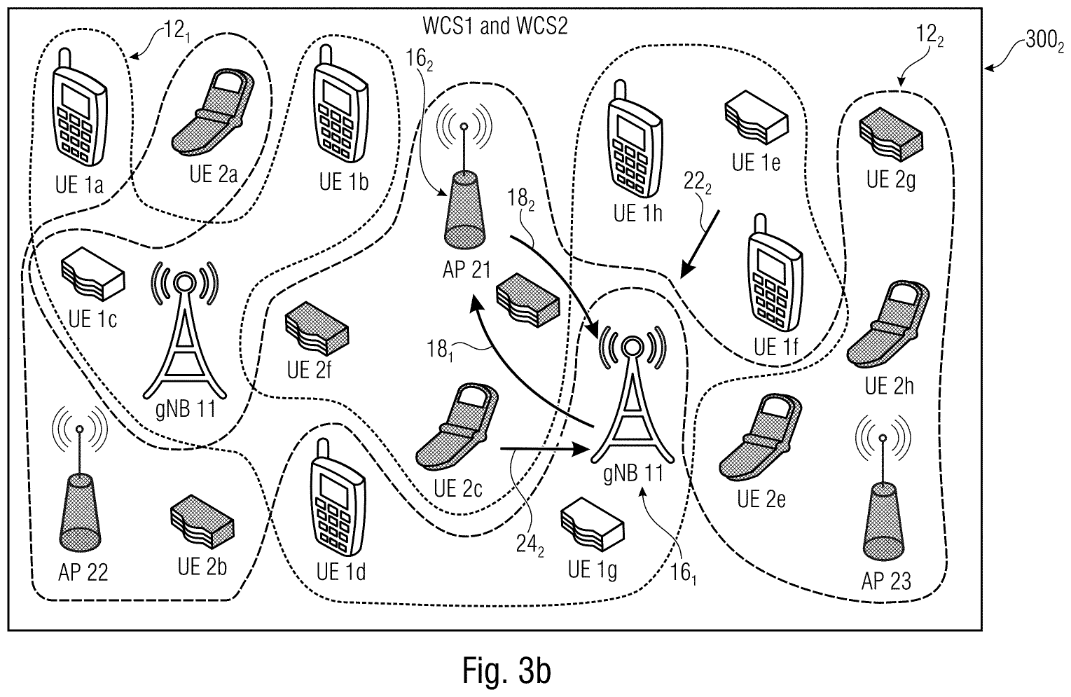

FIG. 3a shows a schematic block diagram of a communication scenario 300₁ according to an embodiment. Communication scenario 300₁ may comprise two or more communication systems (CS) 12₁ and 12₂. With regard to communication system 12₁ being also referred to as CS1, a set of details is illustrated which are given to provide for a better understanding of a communication system but which shall not limit the scope of the present invention.

Communication system 12₁ comprises 1, 2 or even a higher number of, e.g., at least 5, at least 10, or even higher members 14₁ and 14₂ which may, individually or as a group, be implemented, for example, as an apparatus comprising a communication interface to communicate within the communication system 12₁, i.e., a wired interface, a wireless interface and/or an optical interface. A member 14₁ or 14₂ may be a communicating apparatus, e.g., a terminal, a user equipment, an internet-of-things (IoT) device or the like but may also form a sub-system of communication system 12, e.g., in the field of utility grids such as water supply, energy supply or the like, in which active components of the utility grid are controlled via communication. Any other kind of communication interface or communication network may be operated or implemented accordingly.

Communication scenario 300₁ may also comprise at least the communication system 12₂. Communication systems 12₁ and 12₂ may overlap partly or completely in space and at least one of a time, a spectrum and a polarisation, thereby not excluding combinations thereof. That is, operation of one of communication systems 12₁ and 12₂ may be perceived at the other communication system in a way that at least a part of communication in the respective other communication system may be influenced, disturbed or overlapped by operating the communication system 12₁ or 12₂.

A control unit 16 of communication system 12₁ may control communication of at least some of the members of communication system 12₁, e.g., in a specific region, in a specific frequency range, for specific services or the like, but may also control the communication for all of the members.

The control unit 16 may transmit a signal 18₁ relating to a configuration of the communication system 12₁.

The configuration of the first communication system may be an information relating to an operation parameter of the communication system 12₁, information referring to an operation parameter of communication system 12₁ and/or a request to change an operation parameter of the communication system 12₂. In a broader sense, the signal 18₁ contains information that is somehow linked to the configuration of at least one of the communication systems 12₁ and 12₂. For example, the signal 18₁ may contain information relating the configuration of communication system 12₂ to inform communication system 12₂ or a not shown third communication system about the configuration of communication system 12₂. Alternatively, or in addition, control unit 16 is configured to receive a signal 18₂ relating to the configuration of communication system 18₁ or communication system 18₂. The signal 18₂ may provide the control unit 16 with information that allows to determine whether to change at least one operating parameter for operating communication system 12, i.e., to control communication of members 14₁ and/or 14₂ and/or to provide other nodes in scenario 300₁ with requests or information.

A target of signal 18₁ and/or 18₂ is to provide for a high effectiveness of operations of communication networks 12₁ and 12₂, e.g., an increase in the overall throughput of scenario 300, in an overall high communication quality or other aspects to be optimized over more than a single communication system.

FIG. 3b shows a schematic block diagram of a communication scenario 300₂ comprising the communication systems 12₁ and 12₂ each being formed as communication system or wireless communication systems (WCS). By way of non-limiting example, WCS 12₁ may be formed as a mobile communication network comprising UEs as members and gNBs as control units. For example, UE 1a, . . . UE 1g may implement members and one or more base stations gNB11 and gNB12 may implement control units.

WCS 12₂ may be formed in a same region and may be implemented, for example, as a wireless local area network comprising UEs UE2a, . . . UE2h and access points AP21, AP22 and AP23.

To distinguish between the apparatus, a UE is named with a number followed by a letter, wherein the number indicates a membership to communication system 12₁, 12₂ respectively, and the latter allows to distinguish between UEs of a same network. Similarly, gNBs or other control units, e.g., access points are named by use of two digits, the first digit indicating the membership to a network 12₁, 12₂ respectively, the second digit forming an index within the communication system 12₁, 12₂, respectively.

In other words, FIG. 3b presents an example of two wireless communication systems (WCS1 and WCS2), each with its particular radio access technology (RAT). A nomenclature wherein the first digit of the suffix after gNB or UE is used to indicate a particular WCS. For example, the two basestations labelled gNB11 and gNB12 together with the user equipment UE 1a, UE 1b, UE 1c, UE 1d, UE 1e, UE 1f, UE 1g and UE 1h. all belong to WCS1 whereas access points AP21, AP22 and AP23 together with user equipment UE 2a, UE 2b, UE 2c, UE 2d, UE 2e, UE 2f, UE 2g and UE 2h form WCS2. Again, as the basestations and access points provide coverage in an overlapping geographical region there is the potential for inter-WCS interference.

To resolve the possible contention that could exist in the scenario depicted in FIG. 3b, the inventors disclose a method that offers improved inter-WCS co-existence, coordination and communication through one or more means which are categorized as follows:
[NEW Radio Control Channel-System aspects] The use of a NEW Radio Control Channel (NRCC) through which a first WCS provides suitable information to a second WCS from which it can determine the availability of the NRCC, its configuration and capabilities of the first WCS. These capabilities may include standardized or defined features of communication, coordination and collaboration e.g. a set of well-defined commands to trigger responses, synchronization of processes, frames, procedures, channel access or reports.
[NRRC validity and scope-System aspects] The existence of any particular NRCC might be constrained so as to have availability in a given validity area and/or over a given period of time. Such a validity area or period may result from requests, negotiations, inter-MNO agreements, regulatory intervention, cross-border agreements, double taxation treaties, trade partnerships, customs zones, international water ways, international airspace, or as part of a greater government initiative set to destroy the digital divide. The validity and scope may be registered and distributed/made accessible via (a) data base(s).
[Information exchange and storage-Method aspects] The use of different methods of information exchange wherein a WCS provides NRCC information through the use of for example: in-band signalling in SIB; a repository; other implicit signalling means; or any combination of the aforementioned examples.
[Communication protocol-Method aspects] The means to exchange information for example, a local radio resource management (RRM) configuration used at WCS1. This should include defined message types, instruction sets, frame structures, signalling patterns etcetera. Examples of the information exchanged between a first WCS and a second WCS could include: current configurations; future intended channel use; system parameters; beam characteristics; radio settings; device position and orientation; and so on.
[Multilingual-Method aspect] Information can be expressed using different signals, protocols and formats.
[A polyglottal attaché—Apparatus aspect] The means to establish a link via the NRCC including translation and interpretation options.

### Main Features

The following list of high-level features is provided as an introduction to the subsequent detail.
Based on UE identification (measurements) of a second WCS and optionally specific KPIs (interference levels), members of the first WCS
   request the first coordination entity to activate NRCC
   report measurements of the second WCS to the first coordination entity
Based on the UE identifying an NRCC belonging to the second WCS and optionally specific KPIs (interference levels), members of the first WCS
   request the first coordination entity to activate an NRCC in the first WCS
   report measurements related to the observed NRCC (of WCS2) to the first coordination entity, e.g. NRCC Id, signal strength, location in a frame structure, spectrum, beam indices, spatial structure (omni/directional)
   indicate to the first coordination entity the capability of understanding or accessing the channel—members can help to coordinate the channels, including translator and interpreter configuration.
      For example, BT beacons can be used in the proximity of an AP or another UE to identify another WCS. This could be an extension of a random ID to identify the language, an MNO etc.
For coordination of WCSs, signalling information is exchanged, such as
   planned/predicted scheduling decisions of a first WCS to a second WCS, allowing the actions of the second WCS to be adapted—e.g. complementary scheduling, power adjustment, slot/symbol level muting etc.

An authority or several authorities, e.g. a coordination entity, can initiate potential behavioural changes of one or more WCSs. For example, a nominated cluster head can coordinate spectrum usage. Cluster heads can be taken in turn between different WCSs.

A WCS control unit (e.g. base station) may operate as a kind of coordinator and may decide on a pre-defined level of information sharing (e.g. transmission scheduling/transmit parameters, receive parameters, QoS requirements), which will define the interference-protection regime for itself, its users and other WCSs
The higher the level of information disclosure, the greater the interference protection
   a Transmit and scheduling parameters (ex-ante—preamble/post-amble) can include the information on:
      Time-scale of reporting
      Speed, location, identification (e.g. UE, AP)
      Operating channel
      TDD UL/DL pattern/transmission schedule, which allows obtaining knowledge on the intended spectrum use
      Tx beam's power, azimuth and tilt
      Antenna pattern nulls (e.g. in coordinates)
      Experienced channel occupancy (NR-U)
      Waveform etc.
   Receive parameters (ex-post):
      Time-scale of reporting
      Received power
      Rx beam's azimuth and tilt
      Aggregated interference power
      Experienced channel occupancy (NR-U)
      Sensing (check ESC in CBRS)
   QoS/Application level requirements
      Link reliability
      Acceptable interference levels;

A simple frame structure could be used by a WCS for the exchange of its spectrum management decisions to other WCS (BS/AP/UE), with a dynamic slot allocation, depending on the number of active users in the area.
Control information exchange phase
Synchronisation phase (beacon)

As may be seen in FIG. 3b, communication systems 12₁ and 12₂ may overlap in space. Alternatively, but in addition, they overlap in at least one of a time, a spectrum and a polarisation of used resources, which may be referred to as that they interfere each other. Referring again to FIG. 3a, the present invention provides for solutions on how to provide at least one of the responsible control units with information that allows to adapt a configuration of at least one of the communication systems 12₁ and/or 12₂. For example, a control unit in accordance with embodiments may establish a control channel with another control unit, i.e., a control channel between two control units of different communication systems to allow for transmitting and/or receiving signals between the control units. When compared to a data base solution based on storing information in a database by a first entity and possibly reading such information by another entity, such a solution allows to obtain a fast, directed and possibly event-triggered communication.

For example, in the communication scenario of FIG. 3b, control unit 16₁ being named gNB 12 may transmit a signal 18₁ to control unit 16₂ being named AP 21 which may, in turn, transmit a signal 18₂ to control unit 16₁. This implements one example of providing for a control channel, which may be referred to as, in the field of new radio communication, as new radio control channel, an NRCC. However, as will be explained later in more detail, the functionality provided by a broad meaning of such a control channel also relates to providing information about a configuration of the own or a different communication network to the own or a different communication system, the respective control unit or a member thereof, such that also indirect paths of providing communication to a control unit are covered by such a control channel.

For example, control unit 16₁ may transmit signal 18₁ to control unit 16₂ (directly or indirectly) to request a change of a control implemented by control unit 16₂. The control unit may transmit signal 18₁ so as to comprise information relating to at least one of a transmission parameter, a reception parameter, a transmission requirement and/or a reception requirement of a member of the communication system 12₁ and/or of communication system 12₂. Alternatively, or in addition, control unit 16₁ may evaluate such for this information. Accordingly, control unit 16₂ may evaluate such information in signal 18₁.

The transmission parameter may comprise at least one of:
A time-scaling of reporting;
A speed, a location and/or an identification of at least a member of the communication system;
An operating channel;
A time division duplex, TDD, uplink/downlink patter;
A transmission schedule;
A transmission beam power;
A transmission beam location and/or orientation such as azimuth and/or tilt;
An antenna pattern null, e.g., in coordinates;
An experienced channel occupancy, NR-U;
A waveform; and/or
Other relevant parameters.

Alternatively, or in addition, the reception parameter may comprise at least one of:
A time-scale of reporting;
Received power;
A reception beam orientation such as azimuth and/or tilt;
Aggregated interference power;
An experienced channel occupancy, NR-U; and/or
Sensing information for external/independent sensors.

The transmission requirement and/or the reception requirement may comprise at least one of:
A quality-of-service requirement;
A link reliability; and/or
An acceptable interference level.

Control units 16₂ and 16₁ may establish said control channel between each other but may also establish such a control channel with a member of the other communication system. For example, control unit 16₁ may establish the control channel with control unit 16₂ or one of the UEs or a different AP so as to transmit requests to communication system 12₂ on how to adapt its configuration and/or for providing information about a configuration of communication system 12₁ and/or 12₂ to enhance a decision and the control unit 16₂ for adapting its configuration and/or to generate a request, possibly transmitted by signal 18₂ to adapt an operating parameter being set by control unit 16₁.

This example is further detailed in connection with the control unit 16₁. The control unit 16₁ may receive information about the configuration of the communication system 12₂. Such information may be received, for example, by receiving signal 18₂ but may, as an alternative or in addition, be received by a signal 22₂ received from an own member, e.g., UE 1e and/or by receiving a signal 24₂ received from a member UE 2c of communication system 12₂. Such a collecting of information may also incorporate a use of external sensors and/or a use of own sensors. That is, the configuration of one or both of communication systems 12₁ and/or 12₂ may form a basis for adapting a control of the communication system, e.g., control unit 16₁ may adapt a control of communication system 12₁ based on measurement information received. Such measurement information may cause the control unit 16₁ to transmit signal 18₁. The measurement information may relate to a behavior of communication system 12₁ and/or communication system 12₂. For example, the measurement information may be received from at least one of:
A direct sensing performed by the control unit;
An indirect sensing reported to the control unit via a control channel;
An indirect sensing reported by at least one member of communication system 12₁;
A direct sensing reported by at least one member of communication system 12₁;
An indirect sensing reported by at least one member of communication system 12₂;
A direct sensing reported by at least one member of communication system 12₂; and/or
An indirect sensing using at least one external sensor.

Those examples, in particular, refer to the case of an indirect sensing, where reports may be provided through a single-hop communication or a multi-hop communication, e.g., a sensor reporting to the control unit, a sensor reporting to a member of the communication system, the member reporting to the control unit, and/or the sensor reporting to a first member, the first member reporting to a second member, the second member reporting to a further member (including any number of additional hops) and, then finally, a member reports to the control unit.

The control unit may receive the measurement information, in one example, at least from an indirect sensing using the at least one external sensor and may retrieve the measurement information from a data base; it may receive the measurement information from a member of its own communication system 12₁ and/or from a different control unit, which does not exclude receiving the measurement information from a member of the communication system 12₂.

The measurement information may comprise an information relating to at least one of:
A band or channel or frequency to which the measurement relates, e.g., an operated band, channel of frequency of at least one of the communication systems;
A time (absolute or relative) to which the measurement relates;
A direction, position and/or orientation to which the measurement relates, e.g., starting from the node measuring the measurement information;
A polarisation to which the measurement relates;
A sensing resolution of the measurement information; and/or
A similar parameter or other information being of interest in view of controlling a communication system.

The control unit may receive the measurement information using a control channel maintained by the control unit for inter-system communication of communication systems, e.g., between communication systems 12₁ and 12₂, from a node that is a member of the first communication system 12₁ or a node that is not a member of the first communication system 12₁.

The control unit 16₁ may configure and/or reconfigure a behavior of at least one member of communication system 12₁ and/or of the second communication system 12₂ such as the use of radio resources of such a member.

Having obtained information about the configuration of communication system 12₂, control unit 16₁ may implement at least one of the following:

It may determine a condition to change an operating parameter of communication system 12₁ and may change the operating parameter accordingly. Alternatively or in addition, controller 12₁ may determine a condition to change an operating parameter of the communication system 12₂ and may transmit signal 18₁ to one of its own members for forwarding, to a member of communication system 12₂ for further forwarding or sending directly to control unit 16₂, the signal containing information relating to a change of an operating parameter of communication system 12₁, e.g., in terms of informing communication system 12₂ and/or relating to a change of an operating parameter of the second communication system, e.g., in terms of informing communication system 12₂ about an occurred change, e.g., as a feedback, or as a request to request a specific change at communication system 12₂. Those examples exclude changing its own configuration and/or requesting the communication system 12₂ to change its configuration and/or informing the communication system 12₂ about its own configuration or a change thereof, or about the configuration of communication system 12₂ or a change thereof.

Alternatively, or in addition, control unit 16₁ may determine a condition to change an operating parameter of a not shown third communication system. Control unit 16₁ may transmit a corresponding signal to request a control unit of the not shown third communication system to change the operating parameter accordingly. For example, communication system 12₁ may overlap with communication system 12₂ as well as the not shown third communication system, the second and third communication system being non-overlapping with each other or unaware of each other. Therefore, control unit 16₁ may operate as a kind of information source informing the third communication system about the second communication system and/or to find a solution that allows a high effectiveness of operations between the first, second, and third communication system. The control unit 16₁ may, alternatively or in addition, optimize an operation of at least one of the communication systems 12₁, 12₂, and/or the not shown third communication system.

Control unit 13₁ may determine the condition to change the operating parameter of communication system 12₂ and may transmit signal 18₁ containing the information relating to the change of the operating parameter of communication system 12₁ and/or 12₂ such that a control unit receiving the contained information creates the contained information as at least one of:
A suggestion to change the operating parameter;
An offer to change the operating parameter, e.g., responsive to a positive acknowledgement or feedback;
A proposal to change the operating parameter;
A recommendation to change the operating parameter;
A part of a negotiation to change the operating parameter, e.g., in a multi-step negotiation incorporating a reply from the communication system 12₂;
A request to change the operating parameter;
A command to change the operating parameter;
A demand to change the operating parameter; and
A feedback indicating the condition to change the operating parameter.

The terms suggestion, offer, proposal, recommendation, negotiation, request, command and demand may be interpreted as different levels of authority being incorporated into the information. Whilst a suggestion may be considered as a part of information that simply indicates that the change might lead to better results and whilst an offer may indicate a willingness or readiness to change, a request might be understood as a deniable order, whilst a command might be understood as a request that has to be followed under any manageable circumstances.

In accordance with embodiments, the configuration of a communication system, e.g., a configuration being transmitted and/or received with signals 18₁ and/or 18₂ may relate to a past configuration, a present configuration and/or a planned future configuration. While a past configuration may allow to provide information for supporting an analysis of a past scenario, e.g., to obtain helpful information for future operation, a present configuration may also provide for a basis for amending an ad-hoc operation. A planned future configuration may provide information to already avoid or reduce negative effects that would occur in future when operating autonomously.

### Local Coordination Channel

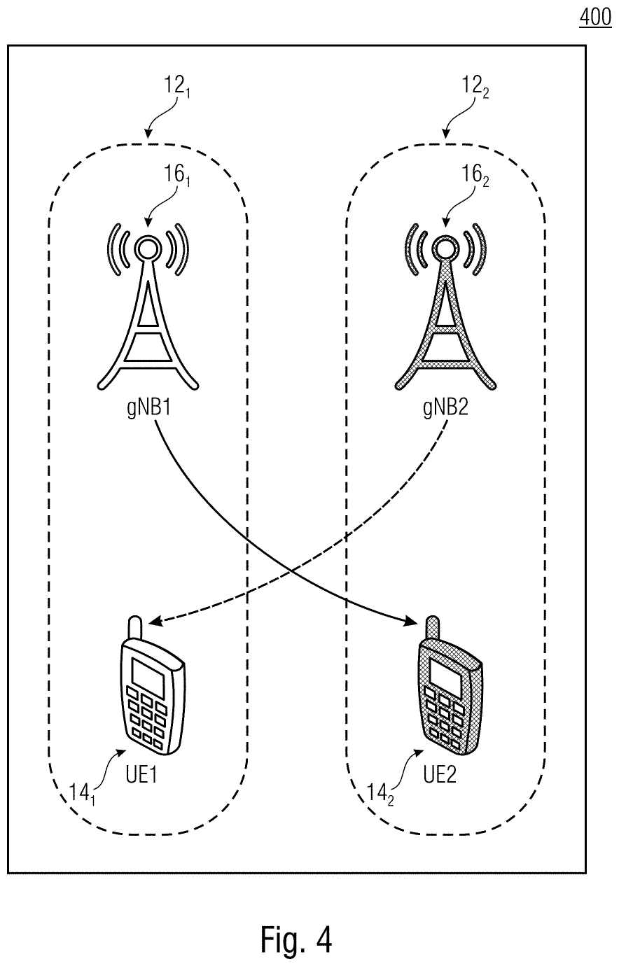

FIG. 4 shows a schematic block diagram of a communication scenario 400 comprising two basestations, control units 16₁ and 16₂, both of which use a similar radio access technology (RAT). In the given example two wireless communication systems (WCSs) are using similar radio access technology (RAT). The basestation gNB1 and the user equipment UE1 belong to a first wireless communication system (WCS1) wherein gNB1 provides the possibility of communication with UE1 (but not UE2). On the other hand, gNB2 and UE2 belong to second WCS (WCS2) wherein gNB2 provides the possibility of communication with UE2 (but not UE1). However, as both gNB1 and gNB2 provide coverage in an overlapping geographical region there is the potential for inter-WCS interference which could result from various effects not limited to include: pattern misalignment; spectrum contention including inter-TDD synchronization failure; spurious emissions; and intermodulation effects). Examples of this are shown in the figure from gNB1 to UE2 and from gNB2 to UE1. While other examples of interference are possible, these are not shown in the figure.

The new channel can be deployed/activated based on local decisions/requirements or event triggered (cross-wise detection of existence of another WCS or upon request due to a performance degradation).

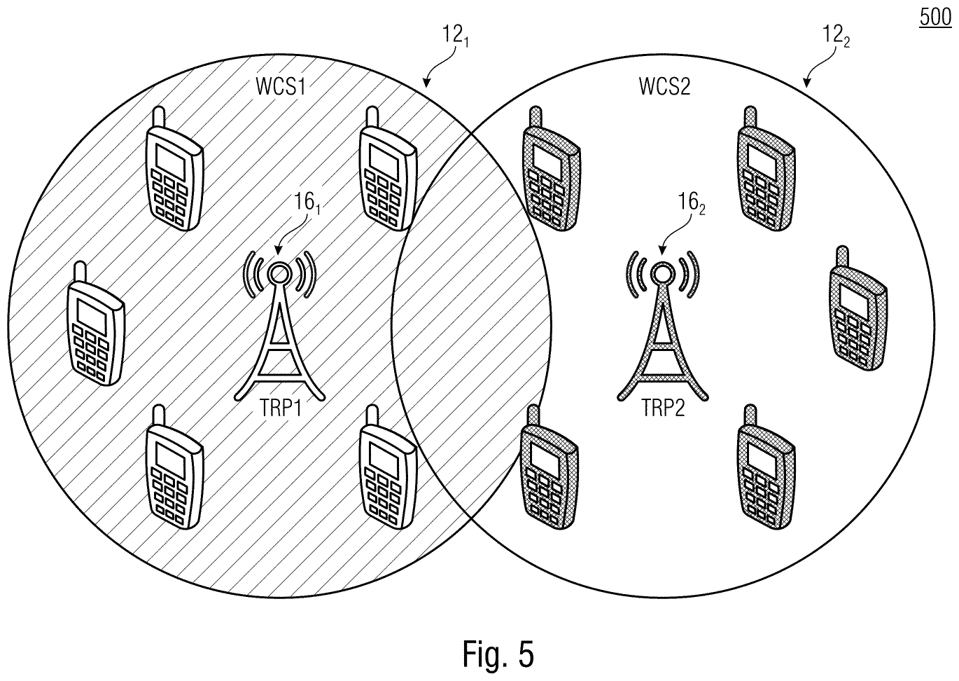

In FIG. 5, which shows a schematic block diagram of a communication scenario in which two wireless communication systems, WCS 1 and WCS2, provide coverage to two geographic regions that overlap in part, although TRP1 and TRP2 are deployed so as to create separate coverage regions for WCS1 and WCS2 respectively, an area of overlap exists wherein interference might result regardless of the type of RAT operated by WCS1 and WCS2. Examples of such effects are adjacent channel and co-channel interference. Members of one WCS may thus experience a degradation in link performance due to the operation of an adjacent channel in the other WCS.

Improved Coexistence in Unlicensed Spectrum (NR-U-NR-U or Wi-Fi-NR-U)

Examples differ from known LBT improvements in multiple ways and provide for further improvements that may be achieved using coordination opportunities via the NRCC.

Current attempts to improve efficiency of LBT in WiFi6/7 and 5G-NRU target a reduction of time waste in case of channel access collisions at the one hand and a fair wireless access to ISM spectrum between systems/links of the same and in particular, of different RATs on the other hand.

Embodiments provide for missing parts as the option of a universal inter-system communication channel allowing systems of the same or different RATs to communicate, co-ordinate and/or collaborate their actions in terms of channel access and channel usage in shared spectrum when operating with overlapping communication footprint and interference range.

Embodiments go beyond known channel observation and probing by random access with short feedback from the receiver side. It has to be mentioned that such individual link addressing approach is possibly not well suited for e.g. group and broadcast scenarios, which play an important role in disaster recovery, emergency scenarios or big events with a high local density of wireless communication channels for emergency services etc.

The proposed solutions may be applied for operation in unlicensed spectrum thus providing improved coexistence and inter-system coordination between two or more WCSs (e.g. NR-U/NR-U, Wi-Fi/Wi-Fi and NR-U/Wi-Fi).

In contrast to LBT, the new approach may provide a dedicated NRCC through at least one of the WCSs. The NRCC can provide information about current and future configurations of one or more WCSs within the same overlapping communication footprint and interference range.

Furthermore, at least one of the other communications systems, e.g., WCSs is possibly able to receive, synchronize, decode and interpret the information provided by the NRCC and additionally initiate an inter-WCS-communication using the NRCC.

Allowing the second WCS to communicate and exchange system settings, scheduling decisions, planned actions with respect to channel occupancy etc. Furthermore, the NRCC can be embedded in the frame structure of the WCS or be positioned out-of-band. Frequency allocation and/or configurations may be provided via a field in the system information block (SIB) in NR or an equivalent system parameter provisioning in Wi-Fi (check correct terminology for Wi-Fi systems) or via a database accessible via various channels available to the WCS.

Furthermore, using the NRCC a second WCS can be informed where to find information about planned channel occupancy by a first WCS examples of which include: the form of a pre-, mid- or post amble; in any suitable form within the frame structure; attached to parts of the frames which might be kept occupied; or planned to be emptied in near future.

A Database-Centric Coordination

Possible relevant constructs of such a solution

Option A: NRCC used to communicate to a local database to assist the decisions on spectrum use
A1: NRCC could be a logical channel/interface
A2: NRCC could be a physical channel (outbound channel) with associated logical channel allowing direct wireless communication with a database

Option B: The coordinator of first WCS is requesting information from a database about a second WCS including configuration of its associated NRCC
Furthermore, the coordinator of the first WCS can task one or more of its members to:
   Obtain further measurements/parameters about the second WCS wherein the additional information/parameters are provided by the database
   Measure/observe the second WCS according to the side knowledge obtained
   Report measurement/observation to the first coordinator
Following the above the coordinator of the first WCS can forward some or all of the information obtained from the member(s) as raw or processed data to the one or more database. A mobile network operator (MNO) can have a database and a regulator can have a data base, therefore several databases may contain information relevant for inter-WCS communication.

Option C: The coordinator of a first WCS is requesting information from a database via the NRCC and/or the coordinator of a second WCS
Together with the request, further parameters e.g. describing a configuration of the first WCS, can be sent to the database; For example, a configuration may be an IP address used by the first WCS which can be used by the database for a direct response to the first WCS.
The response from the database can be provided via the NRCC of the second WCS and/or the coordinator of the second WCS or via an alternative communication channel between the database and the first WCS.

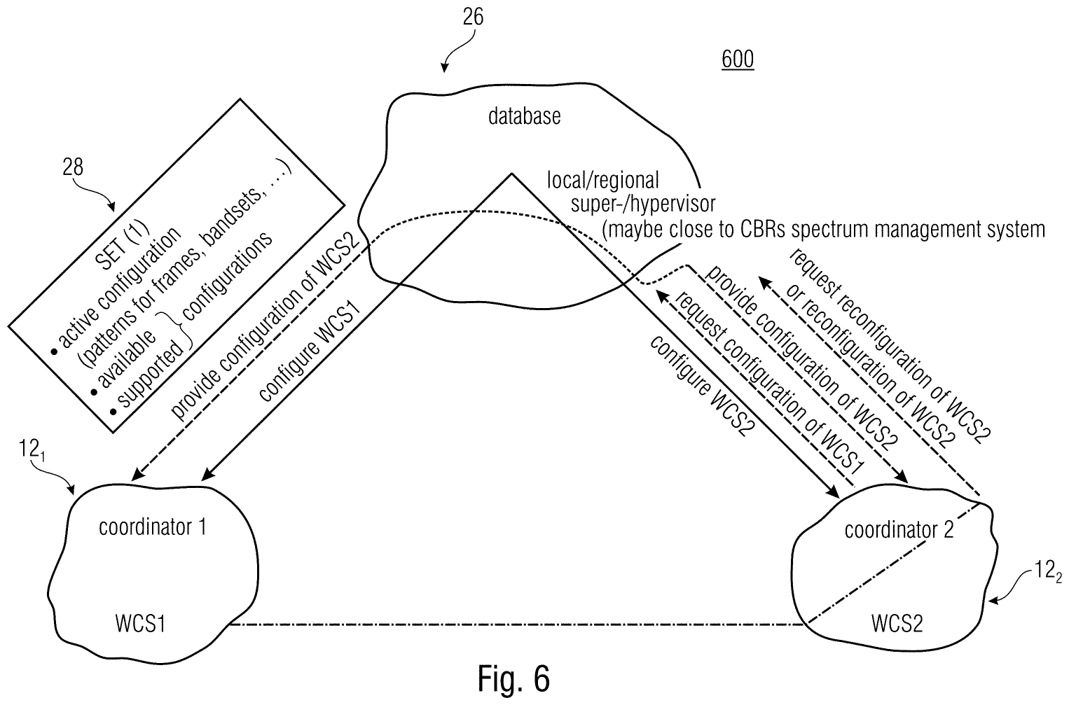

FIG. 6 shows a possible functional connection between multiple WCSs via the NRCC to a common database 26. Furthermore, in connection with WCS2 12₂ the FIG. 6 shows the process of registering with the database and receiving instructions and configurations from the database.

In the depicted example above the WCS1 12₁ is already active in a certain region and has registered to the common data base 26. The registration may include a set 28 of parameters comprising e.g.:
An active configuration (pattern of spectrum/band usage, frame structures, blanking patterns, bandwidths parts, power levels)
Further available or supported configurations as alternatives or options to the active configuration

When another WCS, here labelled WCS2 is entering the coverage footprint of WCS1, WCS2 may register to the common database and request information about and/or configuration of WCS1 from the common data base.

In a next step, the database may provide such information/configuration to WCS2. Additionally, the WCS2 can report its configuration to the database in a similar fashion like done before by WCS1. Such configuration can be forwarded by the database to WCS1 via a push service or on demand AND/OR could be provided to WCS1 directly by WCS2 via the NRCC.

Furthermore, WCS2 could request WCS1 to reconfigure into an alternative configuration, allowing WCS2 a “fair and reasonable” coexistence in the same or overlapping footprint with WCS1. This request, targeting the registered “alternative” configurations supported by WCS1 can be done directly from WCS2 to WCS1 via the NRCC or indirectly via the database. The latter approach may involve further steps and takes longer, but has the advantage of a consistent “picture” of configurations used by WCSs in a particular area.

Furthermore, in case the database is common and considered an authority providing a spectrum management functionality, the database could act with such functionality as a local or regional supervisor/hypervisor for spectrum access coordination. This is to some degree similar to the CBRS approach.

The overall objectives of spectrum access coordination may include but are not limited to:
Interference/collision avoidance
Create/protected”/“exclusive” frequency zones for WCS1 AND/OR WCS2
Define “fair and reasonable” access rules on contention-based part of the spectrum
Permitted energy density, defined in terms of bandwidth, spatial directions etc.

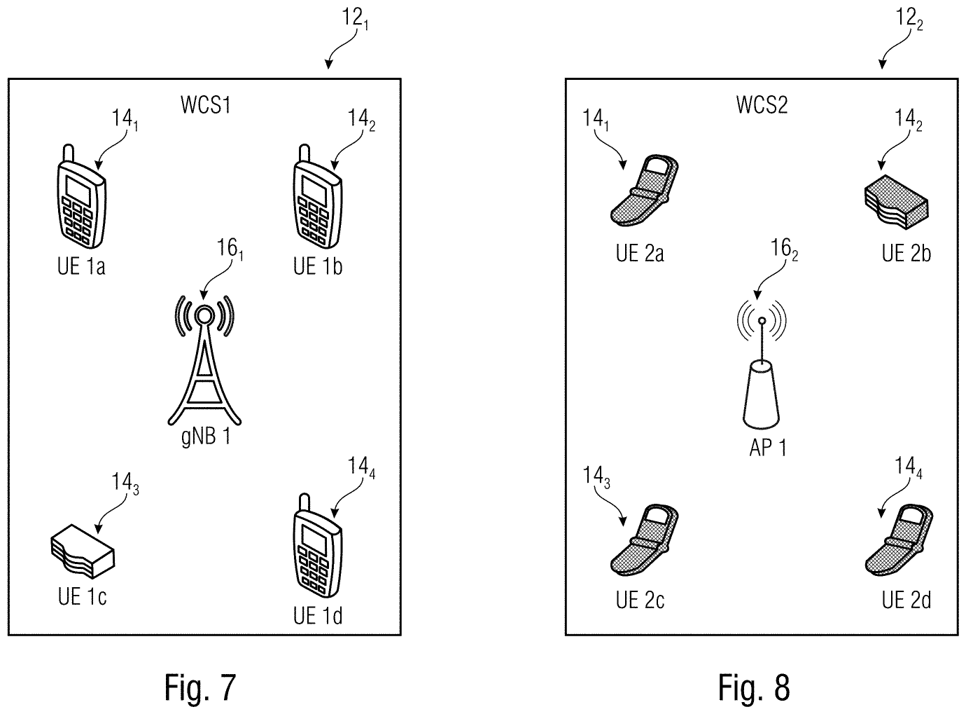

FIG. 7 shows an example of a wireless communication system 12₁ (WCS1) using a particular radio access technology (RAT) in which a basestation (gNB1) implementing control unit 16₁ provides the possibility of creating communication links between it and a number of pieces of user equipment (UE 1a, 1b, 1c and 1d), i.e., members 14₁ to 14₄.

FIG. 8 shows an example of a wireless communication system 12₂ (WCS2) using a particular radio access technology (RAT) in which an access point (AP1) implementing control unit 16₂ provides the possibility of creating communication links between it and a number of pieces of user equipment (UE 2a, 2b, 2c and 2d), i.e., members 14₁ to 14₄.

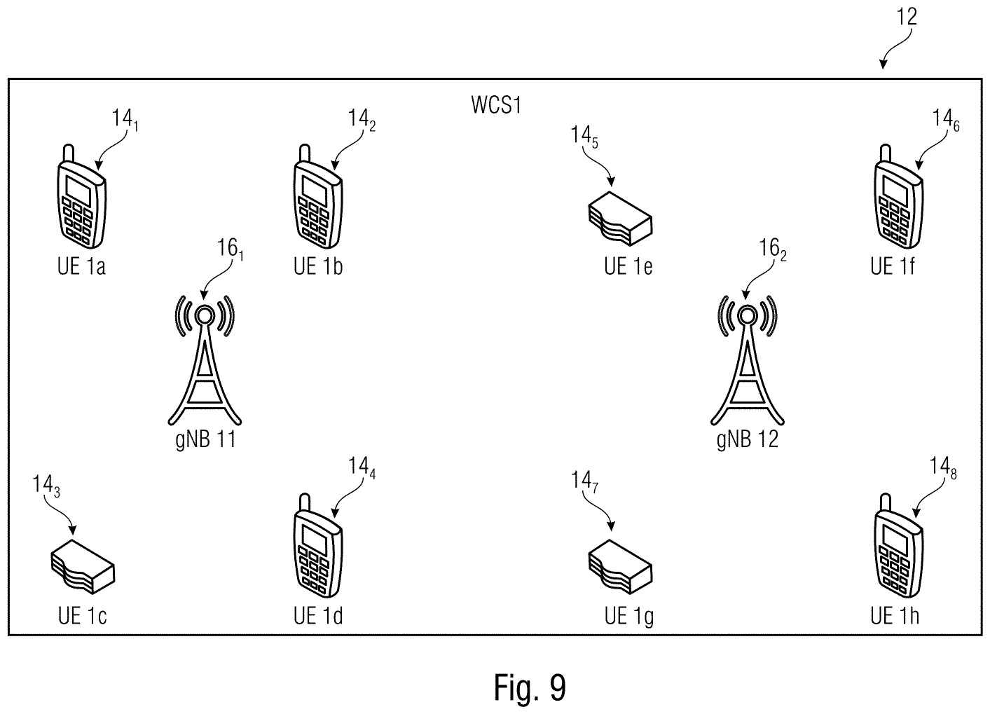

FIG. 9 shows an example of a wireless communication system 12 (WCS1) using a particular radio access technology (RAT) in which basestations (gNB11 and gNB12) implementing control units 16₁ and 16₂ that commonly control communication system 12 and provide the possibility of creating communication links to a number of pieces of user equipment (UE 1a, 1b, 1c, 1d, 1e, 1f, 1g and 1h), i.e., members 14₁ to 14₈.

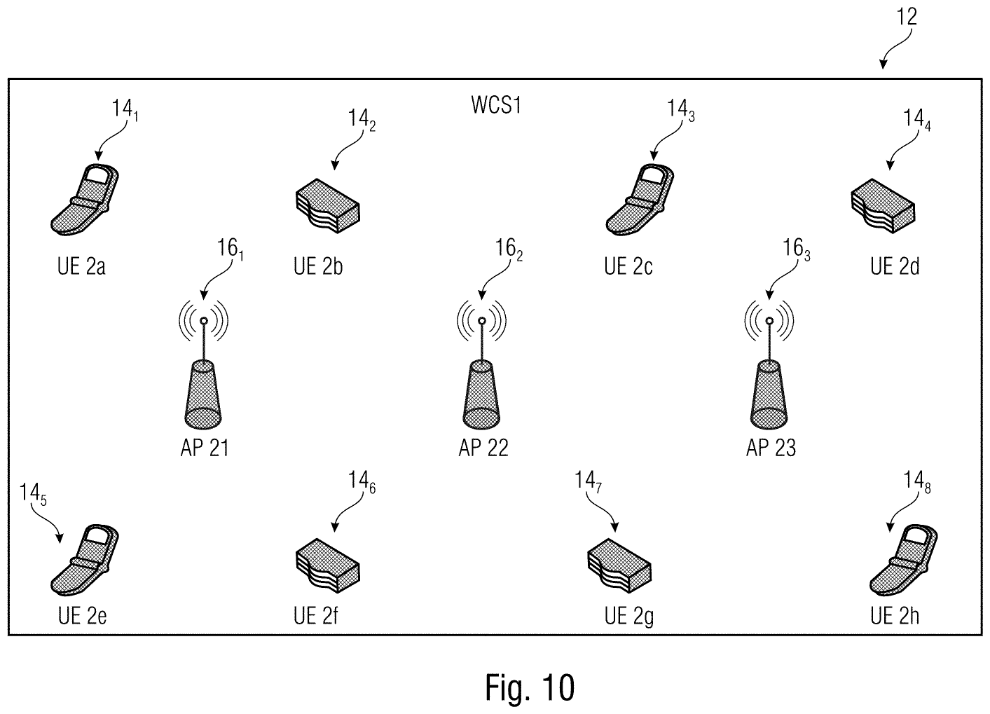

FIG. 10 shows an example of a wireless communication system (WCS2) using a particular radio access technology (RAT) in which access points (AP21, AP22 and AP23) implementing control units 16₁ to 16₃ for commonly controlling communication system 12 and provide the possibility of creating communication links to a number of pieces of user equipment (UE 2a, 2b, 2c, 2d, 2e, 2f, 2g and 2h), i.e., members 14₁ to 14₈.

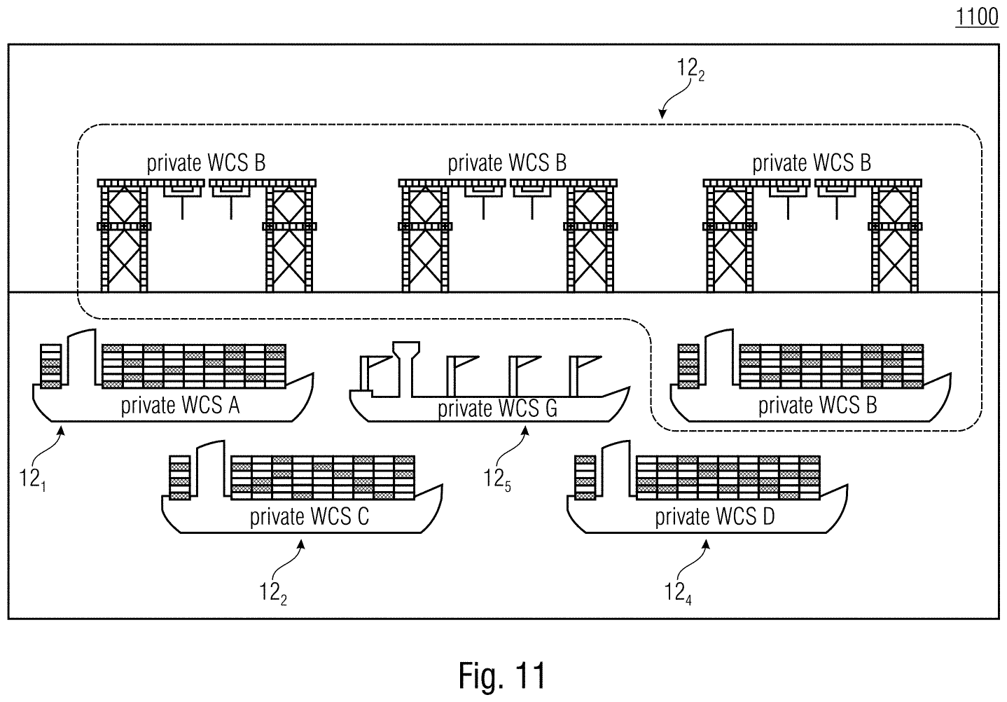

FIG. 11 shows an example of multiple wireless communication systems (WCSs) 12₁ to 12₅ of a communication scenario 1100 being used for maritime and terrestrial applications. The fixed infrastructure used in a port facility uses WCS B of communication system 12₂ whereas at one moment in time an example number of four of the example number of five of the ships in port are using different WCSs (WCS A, WCS C, WCS D and WCS G), i.e., 12₁, 12₃, 12₄and 12₅. The example illustrates the need for an-inter WCS control channel.

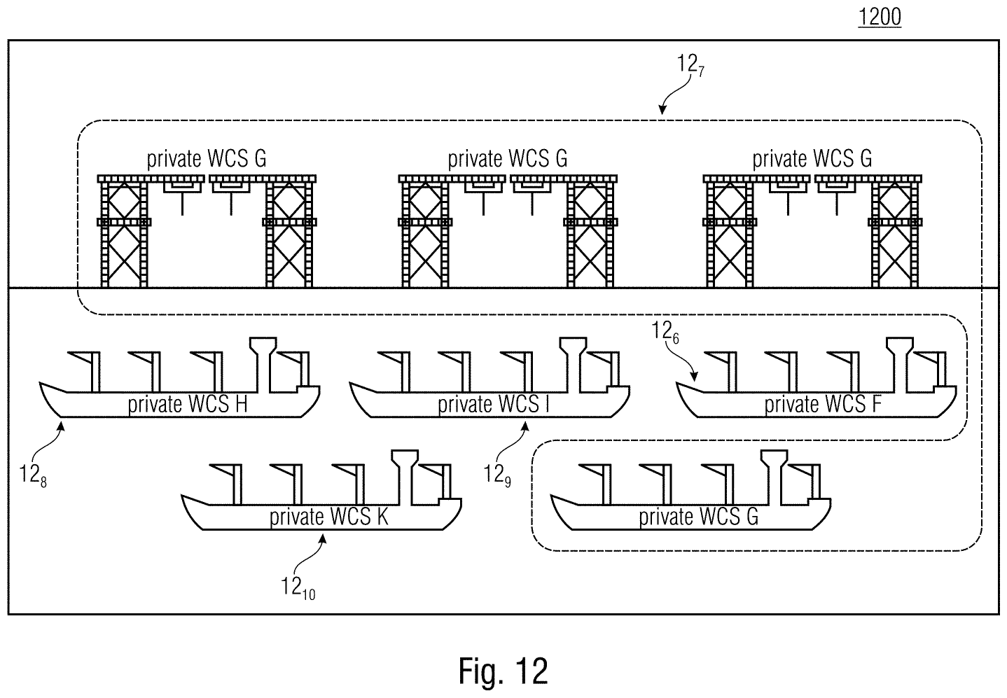

5 FIG. 12 shows a second example of multiple wireless communication systems (WCSs) 12₆ to 12₁₀ of a communication scenario 1200 being used for maritime and terrestrial applications. The fixed infrastructure used in a port facility uses WCS G whereas at one moment in time e.g., four of the e.g., five of the ships in port are using different WCSs (WCS F, WCS H, WCS J and WCS K). The example illustrates the need for an-inter WCS control channel. Although the use of ships is a possible but non-limiting example, it illustrates that a communication scenario may vary over time in view of the arrangement of the whole communication systems.

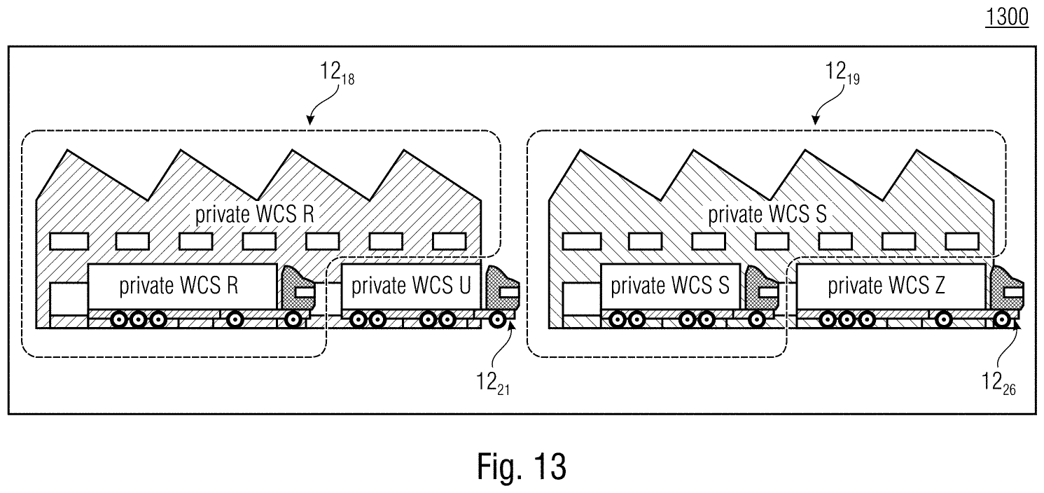

FIG. 13 shows an example of multiple wireless communication systems (WCSs) 12₁₈, 12₁₉, 12₂₁ and 12₂₆ of a communication scenario 1300 being used in road transport and factory or distribution centre applications. The fixed infrastructure equipment in one factory uses WCS R whereas at the distribution centre, WCS S is deployed. Vehicles serving the facilities use WCS R, WCS S, WCS U and WCS Z. The example illustrates the need for an-inter WCS control channel.

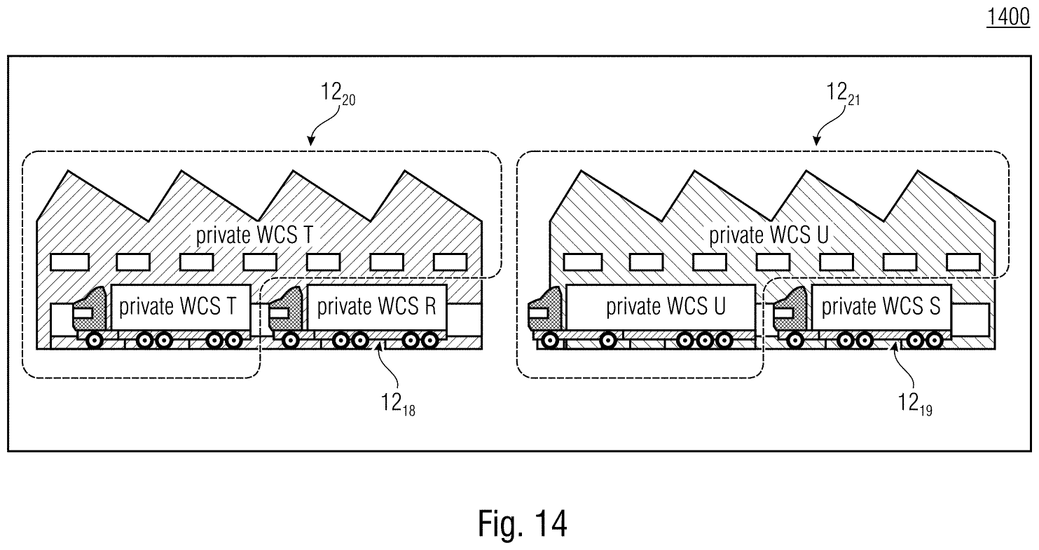

FIG. 14 shows a second example of multiple wireless communication systems (WCSs) 12₁₈, 12₁₉, 12₂₀ and 12₂₁ of a communication scenario 1400 being used in road transport and factory or distribution centre applications. The fixed infrastructure equipment in one distribution centre uses WCS T whereas at the factory, WCS U is deployed. Vehicles serving the facilities use WCS R, WCS S, WCS T and WCS U. The example illustrates the need for an-inter WCS control channel.

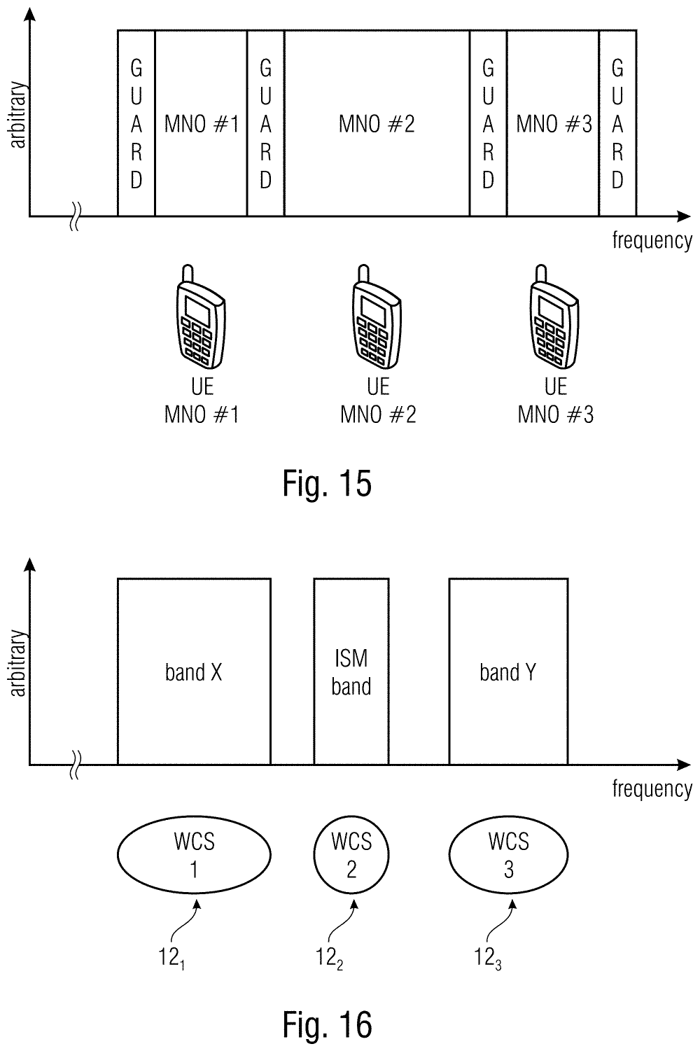

FIG. 15 shows an example of simple spectrum sharing between three mobile network operators, MNO #1, #2 and #3 which may correspond to wireless communication networks 12 overlapping in time. The MNOs use similar radio access technology. In order for one or MNOs to obtain optimized network performance and an enhanced user experience, in-system and inter-band collaboration and coordination is needed between MNOs.

FIG. 16 shows an example of spectrum allocation in which Band X and Band Y represent two individual licensed frequency ranges. Band X typically supports one type of wireless communication system (WCS), shown here as WCS 1. Similarly, Band Y typically supports a different type of WCS, shown here as WCS 2. In between Band X and Band Y, an unlicensed frequency range is available for industrial, scientific and medical (ISM) applications. While a variety of WCSs can utilize this ISM band (also including WCS 1 and/or WCS 2), only WCS 3 is shown. As it is possible that interference resulting from intermodulation or harmonic effects in one band (Band X, Band Y and the ISM band) might affect one or more other bands, improved performance operation of WCS 1, 2 and/or 3 can be obtained through the use of an inter-system and inter-band collaboration and coordination channel (not shown).

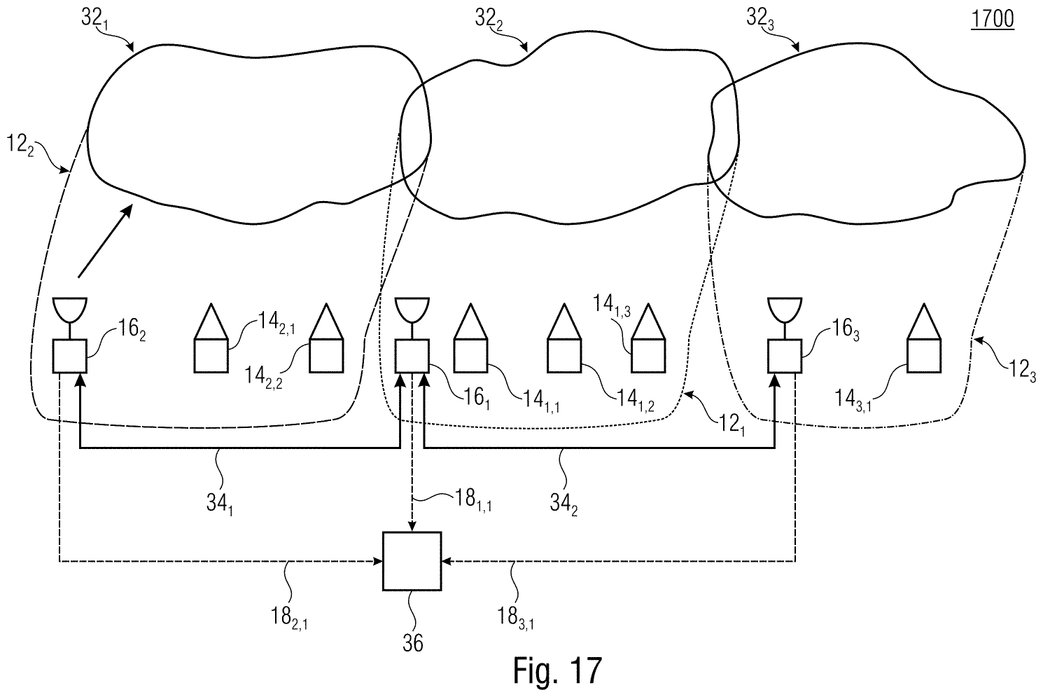

FIG. 17 shows a schematic block diagram of a communication scenario 1700 comprising, for example, at least three communication systems 12₁, 12₂ and 12₃. Whilst communication system 12₁ may overlap, at least in parts, with communication system 12₂ and with communication system 12₃, communication systems 12₂ and 12₃ may possibly be disjointed or not overlapping. By way of example, the communication systems 12₁, 12₂, and 12₃ may be implemented as satellite networks comprising sets 32₁, 32₂, 32₃ respectively of satellites that communication with terrestrial members 14_{i,j}, wherein i refers to the communication system and j is an index within the communication system. It has to be noted that communication scenario 1700 refers to satellites as an example, of dynamic configurations and/or positions or overlaps. The explanation given may be transferred, without limitation to other static or dynamic communication scenarios.

The communication may be unidirectional or bi-directional. For example, member 14_{1,1} may suffer from interference caused by communication using set 32₂. Alternatively, or in addition, member 14_{2,2} may suffer from interference from set 32₁. Any other condition for providing an optimization of at least one communication system 12₁, 12₂, or 12₃ may occur. A member, regardless if it suffers from interference or not, may measure or determine a configuration of an own or different communication system and may provide suitable information to its own control unit, to a control unit of a different communication system or to a different member of an own or a different communication system.

That is, a control unit in accordance with embodiments may transmit signal 18₁ and/or may receive signal 18₂ being illustrated in FIG. 3a and FIG. 3b via a control channel 34₁ and/or 34₂. A control unit may implement or maintain more than one control channel 34 at a same time or simultaneously, wherein a number of control channels may be at least one, at least two, at least three or even larger numbers, e.g., at least five or at least ten. That is, a control channel 34₁ and/or 34₂ may be maintained for transmission purpose, for reception purpose or for both transmission and reception. A control channel in accordance with embodiments, e.g., control channel 34₁ or 34₂ may comprise at least one of a logical channel, a physical channel, an interface or radio interface or combinations thereof. For example, a control channel may be a specific channel being broadcasted in a wireless communication system for informing other nodes or wireless communication systems about a configuration implemented by the control unit or the like. This may allow to implement a member to listen or monitor such a control channel, even without transmitting on it. According to other embodiments, a control channel is a bi-directional channel being used by more than 1 node.

According to the embodiment, the control unit may transmit signal 18₁ of FIG. 3a and/or FIG. 3b to a different control unit controlling another communication system. Alternatively or in addition, the control unit may receive a signal 18₂ from such a different control unit. This may be implemented by the use of a control channel or by the use of any other communication means. According to an embodiment, the control unit may transmit and/or receive signal 18₁, 18₂, respectively via a control channel 34 and/or may receive control information to adapt an operating parameter of the respective communication system. That is, a transmitting, receiving or obtaining knowledge about a configuration of a communication system may lead to an adaptation of operation of the same or a different communication system.

According to an embodiment, the control unit may, as an alternative or in addition, transmit signal 18₁ to a member of its own communication system or a member of a different communication system. The control unit may, as another alternative or in addition, transmit signal 18₁ to a member of its own communication system as a request or instruction to forward information contained in this signal to a member of the second communication system, which may be referred to as a child-to-child communication between different communication systems so as to finally provide a control unit with the respective information.

According to an embodiment, the control unit may receive signal 18₂ from its own member or a member of a different communication system.

According to an embodiment, the control unit may transmit signal 18₁ so as to comprise a coexistence information about a third communication system to at least a member of a second communication system. In FIG. 17, for example, control unit 16₁ may inform a member 14_{2,1}, 14_{2,2} or control unit 16₂ about the presence of communication system 12₃, e.g., a configuration thereof, a behavior thereof or any other relevant parameter. As discussed, the coexistence of three communication systems 12₁, 12₂ and 12₃ may lead to scenarios in which a negotiation or adaptation between only two of those systems might lead to suboptimal results for all three communication systems (or even a higher number) only. The coexistence information may indicate at least one of:
A possible solution for controlling a communication system of communication system 12₁, 12₂ and/or 12₃;
Information, if a collision between at least a subset of communication systems exists;
A solution for a collision between at least a subset of the first to third communication system exists; and/or
Different information relating to an existence of a communication system existing in addition to the first communication system 12₁ and the second communication system 12₂, e.g., where a coexistence strategy is needed.

In other terms, wireless communication system 12₁ may lead to an adaptation of operation of communication system 12₂ to thereby allow communication system 12₁ to adapt its own operation to avoid, reduce or prevent disturbances based on the amended interaction between communication systems 12₁ and 12₂ on the one hand and 12₁ and 12₃ on the other hand.

When referring again to FIGS. 3a and 3b, signal 18₁ may be used to transmit information relating to a configuration of communication system 12₁, e.g., to inform a different control unit about the own configuration. Alternatively, or in addition, signal 18₁ may be used to transmit information relating to a configuration of the different communication system, e.g., communication system 12₂ in FIG. 3b, e.g., to report observations, requesting a change or the like. Further, signal 18₂ may be used to receive information relating to a configuration of communication system 12₂ at communication system 12₁. Alternatively, or in addition, signal 18₂ may be used to receive information relating to a configuration of communication system 12₁.

As discussed, transmitted signals 18₁ and/or 18₂ may relate to an operating parameter of a communication system. The operating parameter may relate to at least one of a system related operating parameter of a communication system, e.g., communication system 12₁, 12₂, and/or 12₃, and a member related operating parameter of a member of such a communication system.

As a system related operating parameter, a parameter may be understood that relates to at least one of a past, current/present and/or future intended or expected configuration of the communication system and/or a system parameter.

Alternatively, or in addition, the member related operating parameter may relate to at least one of a past, current, and/or future intended/expected beam characteristic, radio setting, device position and/or device operation.

The operating parameter may, alternatively or in addition, relate to at least one of:
Synchronization of communication;
A direction of beams;
A direction of noise;
Resource allocation, including time, frequency, code, spatial, radio resources, at least in parts thereof;
Transmission power;
An effective antenna gain;
A power amplifier gain;
A modulation and/or coding scheme;
A frequency range of a channel of sub channel;
A pattern used in a spectrum;
An energy pattern;
A channel/band usage;
A frame structure;
A blanking pattern;
A bandwidth part;
Etc.

The control unit may receive information relating to a configuration of its own communication system, e.g., by receiving signal 18₂. It may adapt the control of its communication system 18₂ accordingly. For example, it may determine a deviation between an intended behavior of the communication system and a behavior that is perceived at a node that provides for information leading to signal 18₂. For example, the control unit may determine a priority of information and may dismiss adaptation of the control, if the priority is below a priority threshold. The priority may be associated with a node, a message type, a situation type or the like. This may allow, on the one hand, to determine if a request, command or the like is to be followed, but may also allow to decide which instructions to follow, if different, possibly contradicting instructions are received, e.g., when receiving more than one signal 18₂.

The priority threshold may be based on a priority level associated with the communication of the members of the own communication system operated by the control unit and/or based on a priority level associated with the control unit.

When referring again to FIG. 17, one or more of the control units may be implemented to transmit a respective signal 18₁ being shown as signals 18_{1,1}, 18_{2,1} and 18_{3,1} to an optional authority node 36 so as to request the authority node to instruct a change of an operating parameter of the first communications system, i.e., of its own, the second communication system or a third communication system which with it possibly has no overlap. That is, for example, control nit 16₂ may also request to adapt a change of an operating parameter being associated with communication system 12₃.

As described, the control unit may transmit signal 18₁ to a different control unit or a member of the same or a different communication system. Accordingly, a control unit in accordance with embodiments may receive information from at least one member of the same communication system, the information indicating a configuration of a different communication system. The control unit may transmit its own signal 18₁ based on the received information. For example, the member may have formed own measurements or at least received information indicating such measurements or other ways of observing a communication system and may provide the control unit with this information as a basis for signal 18₁.

The control unit may implement an adaption of a control of the communication system based on the configuration of the different communication systems, i.e., it may adapt its own control based on the behavior of a different communication system. Optionally, the control unit may inform a control unit of the second communication system about the adaption.

According to an embodiment, a control unit, e.g., control unit 16₁ may provide, to a different communication system, information indicating a capability of the control unit to establish a control channel and/or a capability to read information from a control channel and/or a capability to write information to a control channel and/or information indicating an operating parameter of the communication system. The control channel may be adapted for inter-system communication of the communication systems. That is, the control unit may provide information how it may communicate with other systems and/or how it may adapt its control.

The controller may provide, to a data base, e.g., database 26 in FIG. 6, outside or inside its own communication system, information indicating a capability of the control unit to establish a control channel for inter-system communication of communication systems and/or indicating an operating parameter of the communication system. That is, as an alternative or in addition to provide the information, e.g., by a broadcast or the like, the control unit may also store such information in a database, the database accessible for other control units such that they may derive such information, even if not receiving a signal, directly or indirectly, from the control unit. This may allow for facilitating establishing a control channel.

A control unit in accordance with an embodiment may receive, from such a database inside or outside a communication system 12₁, information indicating a capability of a control unit of a different communication system to establish a control channel for inter-system communication of communication systems and/or indicating an operating parameter of the second communication system; such a control unit may establish the control channel based on the received information.

According to an embodiment, the control unit may receive, from a database inside or outside the communication system, information indicating a capability of a control unit of a different communication system to establish a control channel for inter-system communication of communication systems and/or indicating an operating parameter of the second communication system. The control unit may read the control channel based on the information. I.e., based on the information, it may select or become aware of a control channel and may obtain information therefrom.

According to an embodiment, the control unit may establish a control channel for inter-system communication of communication systems dependent on a validity condition of the communication system 12₁ and/or of the control unit. The validity condition may relate to at least one of:
A location of the control unit or at least a member of the communication system 12₁;
A temporal condition effecting the first communication system;
A received power level;
An interference power level;
A temporal period;
A sector of the first communication system;
A beam direction of the first communication system;
Etc.

Alternatively, or in addition, the validity condition may be associated with at least one of:
A request from, e.g., a coordinating entity, an orchestration unit, a regulating/regulatory unit or a higher level authority;
A negotiation between the first communication system and the second communication system, e.g., between the first and a second control unit, directly or via a coordinating entity or an orchestration unit; or between the control unit and a coordinating entity or an orchestration unit;
An inter-mobile network operator (MNO) agreement;
A regulatory intervention;
A cross-border agreement;
A double taxation treaty;
A trade partnership;
A customs zone;
An international water way;
An international air space; and
As part of a greater governmental initiative.

A mentioned negotiation between at least two communication systems may comprise, for successful and/or unsuccessful negotiation, that the control unit stores a record of the negotiation. The control unit may provide the record to other entities, e.g., automatically, periodically, upon request or the like, which may allow to monitor such events on large scale.

According to an embodiment, the control unit may refuse to establish/operate on the control channel, if the validity condition is not met. This may allow to avoid unnecessary adaption of operating parameters.

According to an embodiment, the control unit may receive information indicating the validity condition and/or information indicating that the validity condition is met and may operate accordingly.

According to an embodiment, the control unit may receive an activation signal indicating to allow or to decline establishing the control channel and may operate accordingly. This may allow to implement a high-level control and/or a deactivation of inter-communication system adaptation, e.g., in case an optimization for only a subset or even only one communication system is needed by the operator.

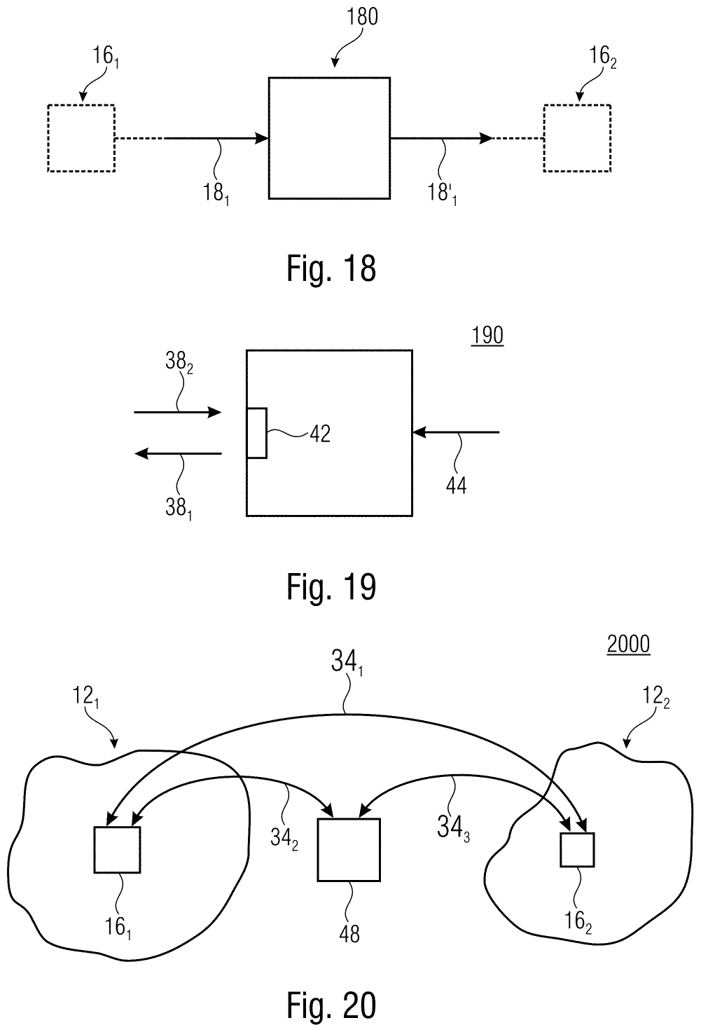

FIG. 18 shows a schematic block diagram of an apparatus 180, which may be referred to as a polyglottal attaché, i.e., a device that may allow to transfer messages of one language or message space into another. The inventors have found that an inter-communication system communication may encounter, in some scenarios, some difficulties. A reason for such difficulties might be, that not every communication entity is suited for communicating in each and every communication space. Apparatus 180 is adapted to communicate, directly or indirectly, with a first control unit 16₁ and a second control unit 16₂, each control unit being configured for controlling communication of members of a respective communication system, e.g., communication systems 12₁ and 12₂. Apparatus 180 is configured for receiving signal 18₁, which may also be signal 18₂ for a different control unit, wherein the signal contains information being mapped to a first message space. As a message space, embodiments refer to at least one of used messages, a set, a structure, a content thereof, for example, one or more used communication protocols and/or capabilities, e.g., a functionality of at least one of the control units. That is, a message space may nevertheless include relays that operate on different frequencies e.g., within a single operator's network. For example, an IAB node can connect to an upstream node (backhaul link) using a different frequency than the frequency it is providing as the node for the UEs on the access. Normally, these frequencies are allocated to the operator. Another example is that IAB node provides access links using NR-U and backhaul links using operators' dedicated frequencies. The known relay can therefore operate on different frequencies AND also knows the format, and message structure etc.

Control unit 16₂ may, however, be not adapted to successfully read such a message or information. Apparatus 180 may map the first signal to a second signal 18′₁ having a different message space. Apparatus 180 may provide signal 18′₁ to control unit 16₂ using the second message space. Therefore, a same or at least comparable information may be provided to communication unit 16₂. A functionality of apparatus 180 may also be referred to as translating one message or message space to another. Functionality of apparatus 180 may be included into a member 14 and/or a control unit 16, without any limitation. For example, when implementing a member 14 with such a functionality, it may receive information or a request being mapped to a first message space and may translate the message to a message space which is readable by an intended receiver, e.g., a control unit. That is, the control unit may transmit a signal by using at least a first communication protocol and a second communication protocol. Signal 18₁ may be transmitted by selecting one of the first communication protocol and the second communication protocol. Alternatively, or in addition, the control unit may receive signal 18₂ by selecting one of the first and the second communication protocol. The control unit may select one of the first communication and the second communication protocol based on a capability of a node intended to receive signal 18₁ or based on a capability of a transmitter of signal 18₂. Such a capability may be determined by the control unit based on at least one of a capability information received from the node or a database, the capability information indicating a capability of the node to establish the control channel; and/or information measured from the members of communication system 12₁, of the control unit, e.g., based on signals monitored from the communication system 12₂.

Alternatively, or in addition, the control unit may transmit signal 18₁ or may receive signal 18₂ from an intermediate communication node relaying the respective signal, the intermediate communication node being, for example, a different control unit, a different member and/or apparatus 180.

A control unit according to the described embodiments may form at least a part of a base station for a communication system but may, alternatively or in addition, form at least a part of a peer for a peer-to-peer communication system.

Whilst some of the description provided referred to the behavior of a control unit, in the following, some functionality of apparatus or members of communication systems will be described by making reference to FIG. 19 showing a schematic block diagram of an apparatus 190 according to embodiments. Apparatus 190 is adapted to transmit a signal 38₁ and/or to receive a signal 38₂. A suitable interface 42 may be part of apparatus 190, wherein the apparatus may be a wired, wireless or optical interface. Apparatus 190 may be configured for transmitting signal 38₁, e.g., to a control unit controlling its communication, using interface 42. Signal 38₁ may comprise a request to the control unit to adapt an operating parameter of the communication system of which apparatus 190 forms a part. Alternatively, or in addition, signal 38₁ may indicate a request to adapt an operating parameter of a different communication system, e.g., when apparatus 190 suffers from interference or the like.

Apparatus 190 may transmit the signal 38₁ based on a signal 44 being received or perceived from an entity, i.e., a member, of the different communication system.

Apparatus 190 may transmit signal 38₁ responsive to at least one of—an event, a measurement or a predefined condition being met. That is, any kind of trigger may cause apparatus 190 to transmit signal 38₁ to request adaptation of its own communication system and/or of a different communication system. For example, the apparatus 190 may perceive interference from the different communication system and may transmit signal 38₁ responsive to the interference.

Alternatively, or in addition, device 190 may perceive a signalling from the other communication system containing control channel information relating to a parameter of a control channel supported by the second communication system. Apparatus 190 may report the control channel information or information derived therefrom to the control unit or to a database, e.g., using signal 38₁.

The parameter may relate to at least one of:
a control channel ID;
signal strength;
a location in a frame structure;
spectrum;
a beam index;
a spatial structure, e.g., omnidirectional or directional
   of the second communication system.

According to an embodiment, apparatus 190 may be implemented differently. Using the interface 42, it may transmit signal 38₁ to its control unit, the signal comprising a request to the control unit to adapt an operating parameter of its own communication system according to side constraints derived from an observed behavior of the second communication system Such constraints may refer to, for example, Tx power, the direction and tilt of transmission, radiation pattern along the main and side-lobes etc.

According to another embodiment, apparatus 190 may be implemented differently. Using the interface 42, the apparatus 190 may transmit signal 38₁ to the control unit so as to comprise a request to the control unit to adapt an operating parameter of its own communication system according to requests received from members or a control unit of a second communication system, e.g., receiving signal 44.

According to another embodiment, apparatus 190 may be implemented differently. Using the interface 42, apparatus 190 may transmit signal 38₁ to an entity of a further communication system, i.e., a member, a control unit or the like. Signal 38₁ may comprise a request to a further control unit of the further communication system to adapt an operating parameter of the further communication system. Apparatus 190 may transmit such a signal based on a received request to be forwarded and/or based on measurements.

The described embodiments referring to apparatus 190 may also be combined with each other. Additionally, and optionally, the apparatus 190 may, in which ever configuration it is implemented, be configured to receive the request being mapped to a first message space and for mapping the request to a second, different message space and for transmitting the request using the second message space.

One or more of the apparatus described herein may be part of a communication system. Embodiments further provide for a communication scenario comprising at least a first communication system and a second communication system, each communication system being controlled by a respective control unit. A node of a first communication system, e.g., communication system 12₁, may transmit a signal to a node of the second communication system, e.g., communication system 12₂ and/or a node of the second communication system may transmit a signal to a node of the first communication system. That is, an inter-system communication is enabled.

Such a communication scenario may be operated by use of a first access technology for the first communication system and a different access technology for the second communication system. Alternatively, the first and the second communication system may be operated by a same access technology. Also being not limited hereto, the access technology may be a radio access technology, RAT. Examples for different RAT are, for example, 2G, 3G, 4G, 5G or higher, wireless local area networks, wireless metropolitan area networks or the like.

Instead of referring to a same or a different access technology, differences to be addressed may also occur, e.g., when providing a same access technology, when implementing a same or a different configuration of this access technology. This may refer, for example, to different frame structures, time schedules, frequency bands or the like.

According to an embodiment, a first and a second communication system of a communication scenario overlap at least partly in space and at least one of a time, a spectrum and polarisation. As described, for example, in connection with FIG. 17, an authority node or a coordinating entity may provide for instructions to one or more of the control units of the communication scenario. For example, the coordinating entity may provide for a synchronization between two communication systems, e.g., using a TDD structure. Therefore, the assignment of uplink and downlink slots/frames may benefit from the use of a common pattern. For example, if one of the communication systems needs or requests to change its pattern, then this could be coordinated with the second communication system.

As a communication scenario embodiment defines a non-stationary combination of communication systems in which at least one of the first communication system and the second communication system is non-stationary. However, this does not exclude to have, at least for a specific time interval, both communication systems unchanged. Other embodiments also provide for stationary combinations of communication systems. An example for non-stationary combinations are dimensional satellite networks, the maritime networks and/or the transportation networks.

According to an embodiment, at least one of the communication systems is a movable system and/or comprises a dynamic control configuration that changes the mutual influence between the communication systems.

A communication scenario according to an embodiment comprises a coordinating entity, e.g., authority node 36, adapted to provide a first control channel to the first communication system and to provide a second control channel to the second communication system to adapt control. When referring again to FIG. 17, signals 18_{1,1}, 18_{2,1} and/or 18_{3,1} may be transmitted via a respective control channel.

Alternatively, or in addition, a signal transmitted from the authority node 36 may be transmitted through such a control channel.

Such a coordinating entity may be adapted to coordinate the control of the first control unit 16₁ and control of at least the second control unit 16₂ based on a combinatory parameter of the first communication network and of the second communication network 12₁ and 12₂, e.g., so as to provide for a high effectiveness of operations, a high global throughput, high global quality or the like. A coordinating unit may, thus, coordinate the control of the first control unit and the control of the second control unit based on the combinatory parameter: For example, the combinatory parameter may refer to a combinatory or common synchronization or the like, e.g., a combinatory throughput, a combinatory quality of service and/or a combinatory latency.

Whilst a coordinating entity may coordinate different communication systems, according to an embodiment, a communication scenario may comprise a higher level authority adapted to provide the first control unit 16₁ and/or the second control unit 16₂ with information indicating control rules relating to at least one of instructions, requirements, conditions or restrictions of controlling a communication network, e.g., based on local regulations or the like. The control unit 16₁ and/or 16₂ may be adapted to implement the control of communication networks accordingly.

According to an embodiment, a communication scenario may comprise a watchdog entity adapted to monitor control provided by the first control unit and/or the second control unit. Such a watchdog entity may report violation of the control against control rules. Such an entity may be part of one of the communication systems 12₁ and/or 12₂ but may also be independent or external of such systems. Possibly, a control unit is unaware of violating a regulation, e.g., when being unaware of results of its control. A watchdog may allow to obtain such information.

According to an embodiment, the communication scenario may comprise an orchestrating entity to orchestrate resources across different network domains of at least one of the first communication system and the second communication system according to an objective and to provide orchestration demands to the first control unit 16₁ and/or the second control unit 16₂ being adapted to operate accordingly.

According to an embodiment relating to a communication scenario, at least one of the control units 16₁ and 16₂ may establish a control channel for inter-system communication of communication systems dependent on a validity condition of one of the communication systems and/or one of the control units. The validity condition may be associated with a negotiation between the first communication system and the second communication system, e.g., between the control units 16₁ and 16₂, directly or via a coordinating entity or an orchestration unit; or between the control unit and a coordinating entity or an orchestration unit, wherein for an unsuccessful and/or successful negotiation, the communication scenario is to store a record of the negotiation. Any node of the communication scenario may be used for storing the record of the negotiation. The communication scenario may be adapted to provide the record, e.g., automatically, periodically, upon request or the like.

Further embodiments relate to methods being implemented by at least one node of a communication system or a communication scenario.

According to an embodiment, a method for operating a control unit controlling communication of members of a first communication system comprises transmitting a first signal relating to a configuration of the first communication system or a different second communication system and/or receiving a second signal relating to the configuration of the first communication system or the second communication system. Optionally, the method comprises receiving, from a higher level authority, information indicating control rules relating to at least one of instructions, requirements, conditions or restrictions of controlling the communication network and controlling the communication network accordingly.

According to an embodiment, a method for operating an apparatus to communicate with a first control unit configured for controlling communication of members of a first communication system and with a second control unit configured for controlling communication of members of a second communication system comprises receiving information from the first control unit, the information being mapped to a first message space. The method further comprises mapping the information to a second, different message space and providing the information to the second control unit using the second message space.

According to an embodiment, a method for operating an apparatus in a first communication system based on a control from a control unit comprises transmitting a signal using an interface, the signal comprising a request to adapt an operating parameter of the first communication system or to adapt an operating parameter of a second communication system as described, for example, in connection with apparatus 190.

According to an embodiment, a method for operating an apparatus to operate in a first communication system based on a control from a control unit comprises transmitting a signal using an interface, the signal comprising a request to adapt an operating parameter of the first communication system according to side constraints derived from an observed behavior of a second communication system.

According to an embodiment, a method for operating an apparatus to operate in a first communication system based on a control from a control unit comprises transmitting a signal using an interface, the signal comprising a request to adapt an operating parameter of the first communication system according to requests received from members or a control unit of a second communication system.

According to an embodiment, a method for operating an apparatus to operate in a first communication system based on a control from a control unit comprises transmitting a signal to an entity of a further communication system using an interface, the signal comprising a request to the further communication system to adapt an operating parameter of the further communication system.

According to an embodiment, a method for operating a communication scenario comprises controlling a first communication system at least partly by implementing a method described herein and controlling a second communication system at least partly by implementing a method as described herein. The method is implemented such that the first control unit receives or transmits the first signal and/or the second control unit receives or transmits the second signal.

FIG. 20 shows a schematic block diagram of a communication scenario 2000 according to an embodiment. For example, communication scenario 2000 comprises two communication systems 12₁ and 12₂, each being controlled by at least one control unit 16₁, 16₂, respectively. As all of the other embodiments described herein, such a communication scenario may be enlarged so as to comprise at least a third communication system and/or at least an additional control unit within a communication system.

Control units 16₁ and 16₂ may communicate via control channel 34 providing at least a unidirectional communication between control unit 16₁ and 16₂, advantageously a bidirectional communication.

Further, communication scenario 2000 may comprise an orchestrator and tier 48 being in communication with control unit 16₁ and control unit 16₂. By way of example, such a communication may be implemented by maintaining a respective control channel 34₂, 34₃, respectively, wherein any other means for communicating may be implemented. Such an orchestrator 48 may be of advantage, when a direct control channel 341 may not be maintained for any reason. It may provide for an alternative route and/or the orchestrator 48 may provide for additional information for controlling communication system 12₁ and/or communication system 12₂. For example, if a direct communication between the control units 16₁ and 16₂ is not possible at the moment, possibly not even when providing additional hops via members of communication system 12₁ or 12₁, then one of the control units that wants to request the other control unit to adapt its control and/or to inform the other control unit about its control may send a message to orchestrator 48 so as to try to reach the other control unit via this alternative route.

In other words, a control unit can be a coordination and/or orchestration unit or may communicate with such a unit. A network or communication system may be understood as being comprised of elements connected by suitable means allowing control via the communication of messages using a known protocol, which is also true in utility grids. A control channel such as an NRCC may provide means to transfer control messages between different networks, control systems respectively. Any network or system can be extended, according to embodiments, by a device allowing transmission and/or reception via the NRCC of another network or system, e.g., a mentioned polyglottal attaché. For example, an application of the NRCC may be to provide an auxiliary reconnection and/or channel, e.g., a radio channel, an optical channel, a power line or the like.

Suggested devices, in accordance with the embodiments, may comply with a regulator's mandate that the equipment is fitted with NRCC and is responsive to control messages sent by the regulator or other authority. Such a mandated equipment may provide information to the regulator, a different authority or a different network, communication system. Further, such a mandated equipment may optionally transmit control messages to another network or communication system. Further, such a mandated equipment may be requested to monitor according to instructions from a regulator. The device may, thus, serve as a watchdog to observe and report and optionally may act as a referee by issuing instructions to a control unit on behalf of the regulator.

According to an embodiment, a control channel may provide message containers, the purpose of which is known only to sender and the intended recipients. For example, such a message may be encrypted in a one-to-one encryption and may comprise, for example, a descriptive part such as a descriptive header or a directed address, such as an IPV6 address. Alternatively, or in addition, a multilingual address header may be implemented allowing that the addressee or a group thereof or recipients or a distribution list may be defined by different levels with regard to security, clearance, permission, authority, encryption or the like. Thereby, without knowing the content of the message, a control message may be forwarded between different communication systems, wherein the transmitter somehow expects that a possibly unknown receiver will somehow receive its message regardless which communication protocols are implemented or the like.

Such a descriptive or forwarding address header may point to a physical address, a termination address or the like and/or may include a route restriction and/or preferences. For example, a route of nodes that has to be used or that has to be avoided for providing the message and/or the response may be indicated. For example, a kind of information indicating, for example, “forward message to manager” which is one level higher than the transmitter may be transmitted until the information message is acted upon.

A device that is equipped with NRCC to two or more communication systems may serve as an orchestrator. An orchestrator can be a member of one or more communication systems but is not required to be such and can, thus, also not be a member of any orchestrated network or communication system.

Embodiments address the challenge of dynamic deployments by proposing a new radio control channel for coordination of communication systems, in particular, wireless communication systems. Embodiments allow provision of:
Means to initiate, establish and maintain inter system communication, coordination and cooperation between multiple WCS.
Means to request, trigger, log and report measurements, observations and (inter) actions, e.g., by providing a protocol to communicate via the NRCC
Facilitate better radio resource usage among multiple WCS resulting from exchange of information via NRCC, e.g., in terms of
   Spectral efficiency
   Faster channel access
   Reduced jitter in channel access, packet delivery, round trip time (RTT)/latency
   Improved reliability in terms of channel availability, access, duration of channel use
Means to communicate between WCS of different RATs directly and indirectly
   over-the-air in static and dynamically changing communication device/node/propagation environment constellations/scenarios
   Over fixed lines e.g. DSL, copper, fibre, satellite links
   Over-the-Top (OTT) using access to the internet by one or more of the multiple WCS
   Involving devices for message forwarding e.g. relays
Means to interoperate between multiple WCS using, e.g., a polyglottal attaché
   Translation/interpretation between messages, protocols, capabilities
Means to provide, identify, receive and/or access and use a common inter-WCS channel using a request to data base
Means to access a DB using the NRCC directly or via NRCC of another WCSs, e.g., using NRCC to access database.

Benefits of Coordinated Spectrum Access:

In the future it is expected that a mentioned control channel NRCC as well as a “watchdog” allows extended use of shared spectrum
Devices/WCSs can enter a particular spectrum e.g. ISM with less limitations on a number of channels, limited power levels, duty cycles, etc.
When registering at the “watchdog” (spectrum access coordination system) or coordinating entity or DB or higher-level authority, the WCS will be allowed to use shared spectrum with less limitations and additional levels of QoS may be provided/granted depending on load etc.
Categories of shared spectrum access/levels of coordination: e.g.
   Level 0 (no coordination/no information sharing): use limited number of bands at certain max level of power
   Level 1 (low level coordination/low level of information sharing): use more bands with more power, but according to some relaxed rules
   Level x (intermediate)
   Level 10 (highest level of coordination/highest level of information sharing): use all or allocated bands with dedicated power level, but according to strict rules
   Incentive: accept more control, supervision and rules in return obtain potentially better access, better QoS, etc.
Means to initiate, establish and maintain inter system communication, coordination and cooperation between multiple WCS.
Means to request, trigger, log and report measurements, observations and (inter) actions, e.g., by providing a protocol to communicate via the NRCC
Facilitate better radio resource usage among multiple WCS resulting from exchange of information via NRCC, e.g., in terms of
   Spectral efficiency
   Faster channel access
   Reduced jitter in channel access, packet delivery, round trip time (RTT)/latency
   Improved reliability in terms of channel availability, access, duration of channel use
Means to communicate between WCS of different RATs directly and indirectly
   Over-the-air in static and dynamically changing communication device/node/propagation environment constellations/scenarios
   Over fixed lines e.g. DSL, copper, fibre, satellite links
   Over-the-Top (OTT) using access to the internet by one or more of the multiple WCS
   Involving devices for message forwarding e.g., relays
Means to interoperate between multiple WCS using , e.g., a polyglottal attaché
   Translation/interpretation between messages, protocols, capabilities
Means to provide, identify, receive and/or access and use a common inter-WCS channel using a request to data base
Means to access a DB using the NRCC directly or via NRCC of another WCSs, e.g., using NRCC to access database in

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

| Abbreviationn | Definition | Further |
|---|---|---|
| 2G | second generation | |
| 3G | third generation | |
| 3GPP | third generation partnership | |
| 4G | fourth generation | |
| 5G | fifth generation | |
| 5GC | 5G core network | |
| ACLR | adjacent channel leakage ratio | |
| AP | access point | |
| ARQ | automatic repeat request | |
| BER | bit-error rate | |
| BLER | block-error rate | |
| BS | basestation transceiver | |
| BT | Bluetooth | |
| BTS | basestation transceiver | |
| CA | carrier aggregation | |
| CBR | channel busy ratio | |
| CBRS | Citizens Broadband Radio | |
| CC | component carrier | |
| CCC | common control channel | |
| CCO | coverage and capacity | |
| CHO | conditional handover | |
| CLI | cross-link interference | |
| CLI-RSS | cross-link interference received | |
| CP1 | control plane 1 | |
| CP2 | control plane 2 | |
| CSI-RS | channel state information | |
| CR | cognitive radio | |
| CRN | cognitive radio network | |
| CU | central unit | |
| DB | database | |
| D2D | device-to-device | |
| DAPS | dual active protocol stack | |
| DC-CA | dual-connectivity carrier | |
| DECT | digitally enhanced cordless | |
| DL | downlink | |
| DMRS | demodulation reference signal | |
| DOA | direction of arrival | |
| DRB | data radio bearer | |
| DSA | Dynamic Spectrum Access | |
| DU | distributed unit | |
| ECGI | E-UTRAN cell global identifier | |
| E-CID | enhanced cell ID | |
| eNB | evolved node b | |
| EN-DC | E-UTRAN-New Radio dual | |
| EUTRA | Enhanced UTRA | |
| E-UTRAN | Enhanced UTRA network | |
| gNB | next generation node-b | |
| GNSS | global navigation satellite | |
| GPS | global positioning system | |
| HARQ | hybrid ARQ | |
| IAB | integrated access and backhaul | |
| ID | identity/identification | |
| IIOT | industrial Internet of things | |
| KPI | key-performance indicator | |
| LSA | Licensed Shared Access | |
| LTE | Long-term evolution | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MR-DC | multi-RAT dual connectivity | |
| NCGI | new radio cell global identifier | |
| NG | next generation | |
| ng-eNB | next generation eNB | node providing E- |
| NG-RAN | either a gNB or an ng-eNB | |
| NR | new radio | |
| NR-U | NR unlicensed | NR operating in |
| OAM | operation and maintenance | |
| OEM | OEM original equipment | |
| OTT | OTT over-the-top | |
| PCI | physical cell identifier | Also known as |
| PDCP | packet data convergence | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RF | radio frequency | |
| RIM | radio access network | |
| RIM-RS | RIM reference signal | |
| RLC | radio link control | |
| RLF | radio link failure | |
| RLM | radio link monitoring | |
| RP | reception point | |
| R-PLMN | registered public land mobile | |
| RRC | radio resource control | |
| RRM | Radio resource management | |
| RS | reference signal | |
| RSRP | reference signal received power | |
| RSRQ | reference signal received quality | |
| RSSI | received signal strength | |
| RSTD | reference signal time difference | |
| RTOA | relative time of arrival | |
| RTT | round trip time | |
| SA | standalone | |
| SCG | secondary cell group | |
| SDU | service data unit | |
| SIB | system information block | |
| SINR | signal-to-interference-plus-noise | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SS | synchronization signal | |
| SSB | synchronization signal block | |
| SSID | service set identifier | |
| SS-PBCH | sounding signal/physical | |
| TAC | tracking area code | |
| TB | transmission block | |
| TDD | time division duplex | |
| TSG | technical specification group | |
| UE | user equipment | |
| UL | uplink | |
| URLLC | ultra-reliable low latency | |
| UTRAN | universal trunked radio access | |
| V2X | vehicle-to-everything | |
| VoIP | voice over Internet protocol | |
| WI | work item | |
| WLAN | wireless local area network | |

[1] 3GPP, “NR and NG-RAN Overall description, Stage 2; V.16.2,” 3GPP, 2020.
[2] 3GPP, “TR 38.828; Cross Link Interference (CLI) handling and Remote Interference Management (RIM) for NR; v16.1,” 3FPP, 2019.
[3] S. Bhattarai, J. J. Park, B. Gao, K. Bian and W. Lehr, “Spectrum Sharing: Ongoing Initiatives, Challenges, and a Roadmap for Future Research,” Transactions on Cognitive Communications and Networking, vol. 2, no. June 2016, pp. 110-128, 2016.
[4] M. Hoyhtya, A. Mammela, A. Chiumento, S. Pollin, M. Forsell and D. Cabric, “Database-Assisted Spectrum Prediction in 5G Networks and Beyond: A Review and Future Challenges,” IEEE Circuits and Systems Magazine, vol. 19, no. 3Q2019, pp. 34-45, 2019.
[5] InterDigital, “R1-1804870, On Physical Layer Procedures for NR-U,” 3GPP, 2018.
[6] Intel, “R1-1806548, Potential designs to support spatial reuse for NR-unlicensed,” 3GPP, 2018.
[7] A. M. Voicu, L. Simić and M. Petrova, “Survey of Spectrum Sharing for Inter-Technology Coexistence,” IEEE Communications Surveys & Tutorials, vol. 21, pp. 1112-1144, 2019.
[8] F. Hu, B. Chen and K. Zhu, “Full Spectrum Sharing in Cognitive Radio Networks Toward 5G: A Survey,” IEEE Access, vol. 6, pp. 15754-15776, 2018.
[9] A. D. Domenico, E. C. Strinati and M. D. Benedetto, “A Survey on MAC Strategies for Cognitive Radio Networks,” IEEE Communications Surveys & Tutorials, vol. 14, no. 1, pp. 21-44, 2012.
[10] C. Shi and G. Li, “Coordinated Blanking for 5G Millimeter-Wave Networks Spectrum Sharing,” in VTC Spring, Nanjing, 2016.
[11] J. Jeon, R. D. Ford, V. V. Ratnam, J. Cho and J. Zhang, “Coordinated Dynamic Spectrum Sharing for 5G and Beyond Cellular Networks,” IEEE Access, vol. 7, pp. 111592-111604, 2019.

1. A control unit configured for controlling communication of members of a first communication system;
wherein the control unit is to transmit a first signal relating to a configuration of the first communication system or a different second communication system; and/or to receive a second signal relating to the configuration of the first communication system or the second communication system.

2. The control unit of claim 1, adapted to control the first communication system as one of a:
a wireless communication system;
an optical communication system;
a wired communication system;
a combination thereof.

3. The control unit of claim 1, wherein the control unit is a first control unit and is to establish a control channel with a second control unit controlling communication of members of the second communication system for transmitting the first signal and/or receiving the second signal.

4. The control unit of claim 1, wherein the control unit is a first control unit and is to establish a control channel with a member of the second communication system controlling for transmitting the first signal and/or receiving the second signal.

5. The control unit of claim 1, wherein based on information about the configuration of the second communication system, the control unit is to do at least one of the following:
determine a condition to change an operating parameter of the first communication system and to change the operating parameter accordingly;
determine a condition to change an operating parameter of the second communication system and to transmit the first signal comprising information relating to a change of an operating parameter of the first communication system and/or the second communication system; and/or
determine a condition to change an operating parameter of a third communication system and to transmit a third signal to request a third control unit controlling the third communication system to change the operating parameter accordingly;
optimise an operation of at least one of the first communication system, the second communication system and the third communication system.

6. The control unit of claim 5, wherein the control unit is at least to determine the condition to change the operating parameter of the second communication system and to transmit the first signal comprising the information relating to the change of the operating parameter of the first communication system and/or the second communication system to cause a control unit receiving the information treating the information as at least one of:
a suggestion to change the operating parameter
an offer to change the operating parameter;
a proposal to change the operating parameter;
a recommendation to change the operating parameter;
a part of a negotiation to change the operating parameter;
a request to change the operating parameter;
a command to change the operating parameter;
a demand to change the operating parameter; and
a feedback indicating the condition to change the operating parameter.

7. The control unit of claim 1, wherein the first communication system and the second communication system overlap at least partly in space and at least one of a time, a spectrum and polarisation.

8. The control unit of claim 1, wherein the configuration of a communication system relates to at least one of:
a past configuration;
a present configuration; and
a planned future configuration.

9. The control unit of claim 1, wherein the control unit is to transmit the first signal and/or to receive the second signal via a first control channel; wherein the control unit is to maintain at least a second control channel to transmit or receive a signal simultaneously.

10. The control unit of claim 1, wherein the control unit is a first control unit and is to transmit the first signal to a second control unit controlling the second communication system.

11. The control unit of claim 1, wherein the control unit is a first control unit and is to receive the second signal from a second control unit controlling the second communication system.

12. The control unit of claim 10, wherein the first control unit is to transmit and/or receive the signal via a control channel to transmit and/or receive control information to adapt an operating parameter of the first communication system and/or of the second communication system.

13. The control unit of claim 1, wherein the control unit is to transmit the first signal to a member of the first communication system or a member of the second communication system.

14. The control unit of claim 1, wherein the control unit is to transmit the first signal to a member of the first communication system to forward information comprised in the first signal to a member of the second communication system.

15. The control unit of claim 1, wherein the control unit is to receive the second signal from a member of the first communication system or a member of the second communication system.

16. The control unit of claim 1, wherein the control unit is to transmit the first signal comprising a coexistence information about a third communication system to at least a member of the second communication system, the coexistence information indicting at least one of
a possible solution for controlling a communications system from the first to third communication system;
information, if a collision between at least a subset of the first to third communication systems exists;
a solution for a collision between at least a subset of the first to third communication systems exists; or
different information relating to an existence of a communication system existing in addition to the first and second communication system.

17. The control unit of claim 1, wherein the control unit is to:
transmit information relating to a configuration of the first communication system with the first signal;
transmit information relating to a configuration of the second communication system with the first signal;
receive information relating to a configuration of the second communication system with the second signal; and/or
receive information relating to a configuration of the first communication system with the second signal.

18. The control unit of claim 1, wherein the first signal or the second signal relates to an operating parameter of the first communication system or the second communication system.

19. The control unit of claim 18, wherein the operating parameter relates to at least one of a system related operating parameter of the first or second communication system and a member related operating parameter of a member of the first or second communication system.

20. The control unit of claim 19, wherein the system related operating parameter relates to at least one of a past, current and/or future intended/expected:
configuration of the communication system; and/or
a system parameter;
and/or wherein the member related operating parameter relates to at least one of a past, current and/or future intended/expected:
beam characteristic;
radio setting;
device position; and/or
device orientation

21. The control unit of claim 18, wherein the operating parameter relates to at least one of:
a synchronisation of communication;
a direction of beams;
a direction of nulls;
a resource allocation, including time, frequency, code, spatial radio resources;
a transmission power;
an effective antenna gain;
a power amplifier gain;
a modulation and/or coding scheme;
a frequency range of a channel or sub-channel;
a pattern used in a spectrum;
an energy pattern;
a channel/band usage;
a frame structure;
a blanking pattern;
a bandwidth part.

22. The control unit of claim 1, wherein the control unit is to receive information relating to a configuration of the first communication system with the second signal; and to adapt the control accordingly.

23. The control unit of claim 1, wherein the control unit is to transmit the first signal to a second control unit of the second communication system to request a change of a control implemented by the second control unit.

24. The control unit of claim 1, wherein a member of a communication system relates to any network element such as at least one of:
a user equipment, UE;
a base station, gNB,
an integrated access backhaul, IAB, node;
a relay;
a control unit, CU;
a functional element which is part of the decision and control loop to configure or reconfigure a communication system

25. The control unit of claim 1, wherein the control unit is to configure and/or reconfigure a behaviour of at least one member of the first communication system or of the second communication system.

26. The control unit of claim 1, wherein the control unit is to transmit the first signal and/or receiving the second signal using a control channel comprising at least one of:
a logical channel;
a physical channel; and
an interface or radio interface

27. A base station for a communication system comprising a control unit according to claim 1.

28. A peer for a peer-to-peer communication system comprising a control unit according to claim 1.

29. An apparatus to communicate with a first control unit configured for controlling communication of members of a first communication system; and with a second control unit configured for controlling communication of members of a second communication system;
wherein the apparatus is configured for receiving a first signal from the first control unit, the information being mapped to a first message space and for mapping the first signal to a second, different message space and for providing the second signal to the second control unit using the second message space.

30. The apparatus of claim 29, wherein the message space relates to at least one of
used messages;
used communication protocols; and
capabilities.

31. An apparatus configured to operate in a first communication system based on a control from a control unit, the apparatus comprising:
an interface;
wherein the apparatus is configured for transmitting a signal to the control unit using the interface, the signal comprising a request to the control unit to adapt an operating parameter of the first communication system or to adapt an operating parameter of a second communication system.

32. The apparatus of claim 31, wherein the apparatus is to transmit the signal based on a signal received from an entity of the second communication system.

33. An apparatus configured to operate in a first communication system based on a control from a control unit, the apparatus comprising:
an interface;
wherein the apparatus is configured for transmitting a signal to the control unit using the interface, the signal comprising a request to the control unit to adapt an operating parameter of the first communication system according to requests received from members or a control unit of a second communication system.

34. An apparatus configured to operate in a first communication system based on a control from a control unit, the apparatus comprising:
an interface;
wherein the apparatus is configured for transmitting a signal to an entity of a further communication system using the interface, the signal comprising a request to a further control unit of the further communication system to adapt an operating parameter of the further communication system.

35. The apparatus of claim 35, wherein the apparatus is to transmit the signal based on a received request to be forwarded.

36. The apparatus of claim 32, wherein the apparatus is to receive the request being mapped to a first message space and for mapping the request to a second, different message space and for transmitting the request using the second message space.

37. A communication scenario comprising:
a first communication system being controlled at least partly by a first control unit according to claim 1; and
a second communication system being controlled at least partly by a second control unit according to claim 1;
wherein a node of the first communication system is to transmit a signal to a node of the second communication system and/or wherein a node of the second communication system is to transmit a signal to a node of the first communication system.

38. The communication scenario of claim 37, wherein the first communication system is operated by use of a first access technology; and
wherein the second communication system is operated by use of a different second access technology; or wherein the second communication system is operated by use of a same access technology, RAT.

39. The communication scenario of claim 38, wherein the first communication system is operated by use of configuring a first access technology; and
wherein the second communication system is operated by use of a different configuration of the first access technology; or wherein the second communication system is operated by use of a same configuration of the first access technology.

40. The communication scenario of claim 37, wherein the first communication system and the second communication system overlap at least partly in space and at least one of a time, a spectrum and polarisation.
